(19) United States
(12) Patent Application Publication
(10) Pub. No.: US 2016/0084659 A1
(43) Pub. Date: Mar. 24, 2016

(54) MAGNETIC FIELD MAPPING AND INDOOR LOCATION SENSING

(71) Applicants: XUE YANG, Arcadia, CA (US); SHENG ZHAO, Riverside, CA (US); LEI YANG, Hillsboro, OR (US)

(72) Inventors: XUE YANG, Arcadia, CA (US); SHENG ZHAO, Riverside, CA (US); LEI YANG, Hillsboro, OR (US)

(21) Appl. No.: 14/495,626

(22) Filed: Sep. 24, 2014

(51) Int. Cl. G01C 21/20; G01C 21/08

(52) U.S. Cl. CPC G01C 21/206; G01C 21/08

(57) ABSTRACT

Aspects of the disclosure relate to location sensing based at least on magnetic measurements within an environment. In certain aspects, the location sensing contemplates several environment and/or operational conditions of an electronic device that conducts the sensing, including soft iron variations, motion characteristic of the device, and/or the elevation of the device. In other aspects, magnetic mappings for the environment can be generated in accordance with one or more of such conditions, and accurate location sensing can be achieved based at least on such mappings and magnetic measurements at a location of the device within the environment.

### BACKGROUND

Providing accurate estimates of indoor location of an electronic device is becoming increasingly important. Certain conventional technologies have generally relied upon indoor access points to provide estimates of indoor position of an electronic device. Yet, the accuracy of such estimates depends largely on the density of the access points present in the indoor environment in which the electronic device is located. In addition, radio signal variations (such as path loss, non-coherence, echoes, and the like) typically prevent achieving sub-meter accuracy via access-point-based localization.

### BRIEF DESCRIPTION OF THE DRAWINGS

The accompanying drawings are an integral part of the disclosure and are incorporated into the subject specification. The drawings illustrate example embodiments of the disclosure and, in conjunction with the description and claims, serve to explain at least in part various principles, features, or aspects of the disclosure. Certain embodiments of the disclosure are described more fully below with reference to the accompanying drawings. However, various aspects of the disclosure can be implemented in many different forms and should not be construed as limited to the implementations set forth herein. Like numbers refer to like, but not necessarily identical, elements throughout.

FIG. 1 illustrates an example of operational stages for magnetic mapping and indoor location sensing in accordance with one or more aspects of the disclosure.

FIG. 2A illustrates an example of an operational environment for magnetic mapping and indoor location sensing in accordance with one or more aspects of the disclosure.

FIG. 2B illustrates an example of a computing device for magnetic mapping and indoor location sensing in accordance with one or more aspects of the disclosure.

FIG. 2C illustrates an example of a radio unit that can be integrated into the example computing device illustrated in FIG. 2B in accordance with one or more aspects of the disclosure.

FIG. 3A illustrates an example of an indoor environment for magnetic mapping and indoor location sensing in accordance with one or more aspects of the disclosure.

FIG. 3B illustrates an example of an observed representation of a spatial distribution of magnetic field within an indoor environment.

FIG. 4 illustrates examples of observed spatial distributions of magnetic field within an indoor environment.

FIG. 5 illustrates an example of another operational environment for magnetic mapping and indoor location sensing in accordance with one or more aspects of the disclosure.

FIGS. 6-7 illustrate other examples of observed spatial distributions of magnetic field in mutually orthogonal directions within an indoor environment in accordance with one or more aspects of the disclosure.

FIGS. 8-9 illustrate other examples of observed spatial distributions of magnetic field in mutually orthogonal directions at different heights within an indoor environment in accordance with one or more aspects of the disclosure.

FIG. 10 illustrates an example normalization interval for location sensing in accordance with one or more aspects of the disclosure.

FIGS. 11, 12, and 13 illustrate examples of methods in accordance with one or more aspects of the disclosure.

FIG. 14 illustrates an example computational environment in accordance with one or more aspects of the disclosure.

### DETAILED DESCRIPTION

The disclosure recognizes and addresses, in at least certain aspects, the issue of indoor location sensing. In certain aspects, this disclosure provides techniques and/or devices to leverage or otherwise utilize a magnetic sensor (such as a solid-state magnetometer) and an inertial sensor (such as a solid-state accelerometer) for accurate indoor location sensing. Conventionally, magnetometers have primarily been used as compasses, which is often problematic in indoor environments due to magnetic field distortions caused by building material/structures, metal objects, and the like. This disclosure leverages or otherwise utilizes indoor magnetic field distortions to establish magnetic measurements that serve as location signature for accurate indoor location sensing. To at least such an end, in certain aspects, the disclosure contemplates several environment and/or operational conditions, including the soft iron variations in different environments, motion characteristic of the user, and the height of the user, which permit generating useful magnetic mappings and accurate location sensing based at least on such mappings. In at least certain embodiments, the disclosure can achieve sub-meter location accuracy via magnetic measurements as location signature.

At any location, the Earth's magnetic field can be represented by a three-dimensional vector, which may be referred to as a magnetic field vector. A magnetic sensor, such as a 3-axis magnetometer, can probe the projection of the magnetic field vector into the 3 dimensional sensor coordinate frame. In most indoor environments, magnetic field distortions may exist due to the presence of ferromagnetic structures. The magnetic field distortions can depend on location, and can include hard iron distortions and soft iron distortions. In one example, without intending to be bound by theory and/or modeling, hard iron distortions may be caused by permanent magnetic source(s) and it may shift the magnetic measurements (which also may be referred to as “readings”) in each of the 3 axes of the magnetic sensor. In one example, the shift may be constant and may depend on position. In another example, without intending to be bound by theory and/or modeling, soft iron distortions may be caused by the interaction between the magnetic field and structures (such as metal objects, iron, and the like) present in an environment in which an electronic device is located. Therefore, without intending to be bound by theory and/or modeling, the soft iron distortion may depend at least on the relative orientation between the magnetic field and the object. In one example, such a magnetic distortion can be observed by rotating an electronic device containing the magnetic sensor about a fixed point in the space.

In the presence of magnetic distortions (either hard iron distortions, soft iron distortions, or both), in at least certain aspects, measurements performed by or otherwise obtained with a magnetic sensor at different positions can yield different observed magnetic fields vectors. Accordingly, magnetic measurements within an environment (e.g., an indoor environment or a semi-outdoor environment (such as a semi-open parking deck) can be utilized or otherwise leveraged as spatial location signatures associated with the environment—herein, such signatures can be collectively referred to as “magnetic field footprint” of the environment. In addition, as described herein, location of an electronic device that can probe the magnetic field within an environment can be estimated or otherwise determined based at least on the magnetic field footprint for the environment.

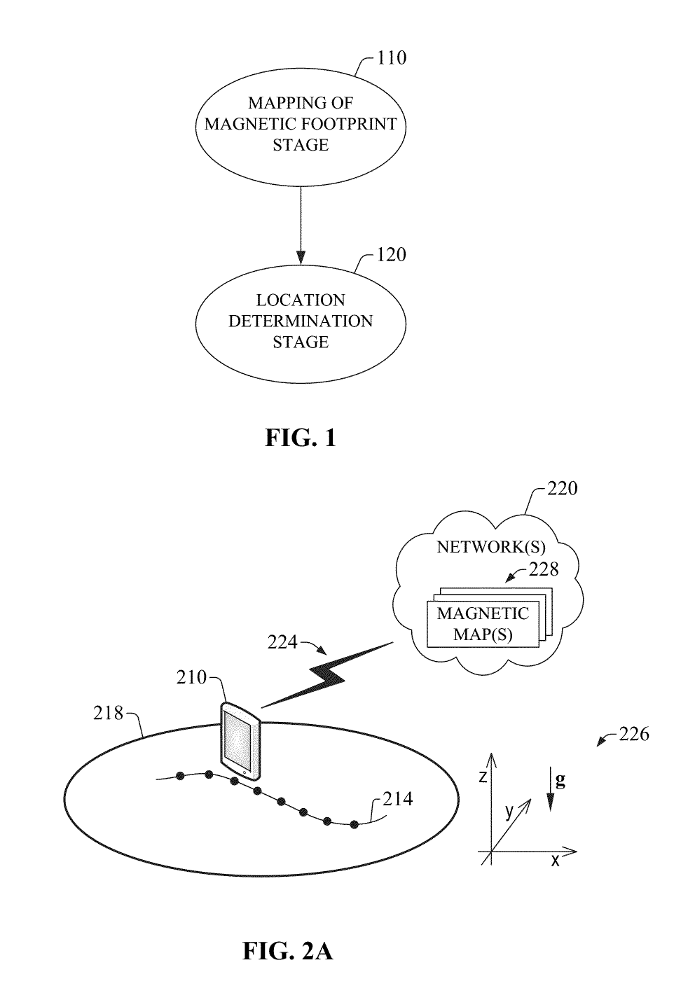

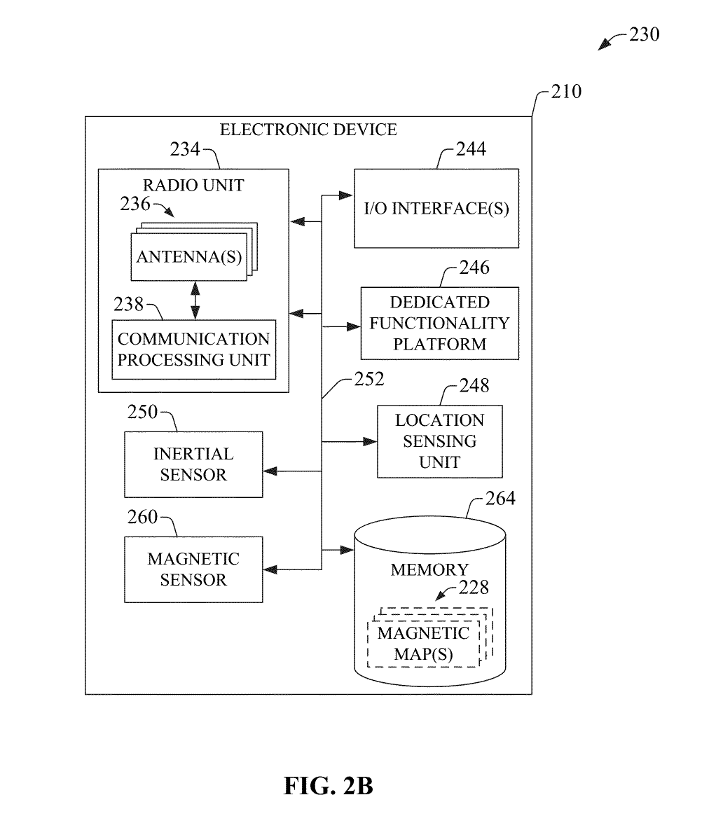

As illustrated in FIG. 1, at least two stages can be implemented or otherwise relied upon to determine a location estimate of a device within an environment based at least on the magnetic field footprint (or, more simply, “magnetic footprint”) of the environment. In one example, a first stage, which is referred to as mapping of magnetic footprint stage 110 (or, more simply, magnetic mapping stage 110), can be implemented in order to assess (e.g., probe or otherwise measure) the spatial distribution of the magnetic field within the environment. Implementation of the stage 110 can include magnetic measurements at predetermined locations in order to generate, or update, a map or spatial distribution of a metric (e.g., a scalar or a vector) representative or otherwise indicative of a magnetic field vector at a specific location. The spatial distribution of such a metric can include position dependent values that are representative or otherwise indicative of the magnetic footprint in the environment. Such values can be retained in one or more memory elements, such as in an information storage or repository, as a reference magnetic signature or footprint information resource (e.g., database). As an illustration, FIG. 2A presents an example environment 218 in which an electronic device 210 can traverse a path 214 while performing a measurement of the magnetic field at certain locations (represented with solid dots) within the path 214. In one example, each location may be represented by a position vector r=(x,y,z) in the Earth coordinate system (represented with a Cartesian coordinate system), where x and y represent in-plane coordinates of the location, and the z coordinate represents elevation in a direction that is aligned with the direction of gravity. The electronic device 210 can communicate information acquired via the measurements to one or more network(s) 220. In one aspect, at least a portion of such information can convey a magnetic metric for each of the locations in the path 214, where the magnetic metric is representative or otherwise indicative of the magnetic field at a respective location. In at least certain embodiments, the information can be communicated wirelessly via one or more links 224, and can be retained in one or more memory elements 228 (which may be referred to as magnetic map(s) 228). It should be understood and appreciated that the magnetic map(s) 228 can be distributed among several repositories or can reside within a single repository. In certain embodiments, in addition to or in the alternative, the magnetic map(s) 228 may be contained within the electronic device 210.

In at least certain embodiments, such as example embodiment 230 shown in FIG. 2B, the electronic device 210 (also herein referred to as computing device 210) can include a magnetic sensor 260 that can probe the magnetic field at a location of the electronic device 210. In one example, the magnetic sensor 260 can be embodied in or can include a solid-state three-axis magnetometer, which can provide at least three readings, or information structures, indicative or otherwise representative of three components of the magnetic field in a sensor reference frame. In addition, the electronic device 210 can include an inertial sensor 250, such as a solid state accelerometer or a gyroscope, which can provide readings, or information structures, indicative or representative of orientation (e.g., yaw, pitch, and/or roll) of the electronic device 210. The information indicative or representative of the orientation of the electronic device 210 can be utilized or otherwise leveraged to transform the readings indicative or otherwise representative of the magnetic field in the sensor reference frame to three magnetic components in the Earth coordinate system. As such, in the example embodiment 230, the electronic device 210 can include a location sensing unit 248 that can utilize orientational measurements from the inertial sensor 250 to transform one or more readings from the magnetic sensor in the sensor coordinate system to respective one or more components in the Earth reference frame. In one example, the location sensing unit 248 can include a coordinate transformation unit (not depicted in FIG. 2B) that can perform the transformations from sensor coordinate system to Earth coordinate system as described herein.

In addition, in the environment illustrated in FIG. 2A, the electronic device 210 can wirelessly communicate information indicative or otherwise representative of a magnetic measurement to a network or a component thereof. Therefore, in one aspect, the electronic device 210 can include a radio unit 234 having one or more antennas 236 and a communication processing unit 238 that can process at least wireless signals in accordance with one or more radio technology protocols and/or modalities (such as multiple-input-multiple-output (MIMO), single-input-multiple-output (SIMO), multiple-input-single-output (MISO), and the like). Each of such protocol(s) can be configured to communicate (e.g., transmit, receive, or exchange) data, metadata, and/or signaling over a specific air interface. The one or more radio technology protocols can include 3^{rd} Generation Partnership Project (3GPP) Universal Mobile Telecommunication System (UMTS); 3GPP Long Term Evolution (LTE); LTE Advanced (LTE-A); Wi-Fi protocols, such as those of the Institute of Electrical and Electronics Engineers (IEEE) 802.11 family of standards; Worldwide Interoperability for Microwave Access (WiMAX); radio technologies and related protocols for ad hoc networks, such as Bluetooth or ZigBee; other protocols for packetized wireless communication; or the like). The communication processing unit 238 also can process non-wireless signals (e.g., analog, digital, optical, a combination thereof, or the like). In one embodiment, e.g., example embodiment 270 shown in FIG. 2C, the communication processing unit 238 can include a set of one or more transmitters/receivers 274, and components therein (amplifiers, filters, analog-to-digital (A/D) converters, etc.), functionally coupled to a multiplexer/demultiplexer (mux/demux) unit 278, a modulator/demodulator (mod/demod) unit 286 (also referred to as modem 286), and a coder/decoder unit 282 (also referred to as codec 282). In one example, each of the transmitter(s)/receiver(s) can form respective transceiver(s) that can transmit and receive wireless signal (e.g., electromagnetic radiation) via the one or more antennas 236.

Electronic components and associated circuitry, such as mux/demux unit 608, codec 612, and modem 616 can permit or facilitate processing and manipulation, e.g., coding/decoding, deciphering, and/or modulation/demodulation, of signal(s) received by the electronic device 210 and/or signal(s) to be transmitted by the electronic device 210. In one aspect, received and transmitted wireless signals can be modulated and/or coded, or otherwise processed, in accordance with one or more radio technology protocols (e.g., 3GPP UMTS; 3GPP LTE; LTE-A; Wi-Fi protocols; WiMAX; radio technologies and related protocols for ad hoc networks, such as Bluetooth or ZigBee; other protocols for packetized wireless communication; or the like).

In addition, the electronic components in the described communication unit, including the one or more transmitters/receivers 274, can exchange information (e.g., data, metadata, code instructions, signaling and related payload data, combinations thereof, or the like) through a bus 284, which can embody or can comprise at least one of a system bus, an address bus, a data bus, a message bus, a reference link or interface, a combination thereof, or the like. Each of the one or more receivers/transmitters 274 can convert signal from analog to digital and vice versa. In addition or in the alternative, the receiver(s)/transmitter(s) 274 can divide a single data stream into multiple parallel data streams, or perform the reciprocal operation. Such operations may be conducted as part of various multiplexing schemes. As illustrated, the mux/demux unit 278 is functionally coupled to the one or more receivers/transmitters 274 and can permit processing of signals in time and frequency domain. In one aspect, the mux/demux unit 278 can multiplex and/or demultiplex information (e.g., data, metadata, and/or signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition or in the alternative, in another aspect, the mux/demux unit 278 can scramble and spread information (e.g., codes) according to most any code, such as Hadamard-Walsh codes, Baker codes, Kasami codes, polyphase codes, and the like. The modem 286 can modulate and demodulate information (e.g., data, metadata, signaling, or a combination thereof) according to various modulation techniques, such as frequency modulation (e.g., frequency-shift keying), amplitude modulation (e.g., M-ary quadrature amplitude modulation (QAM), with M a positive integer; amplitude-shift keying (ASK)), phase-shift keying (PSK), and the like). In addition, one or more processors that can be included in the electronic device 210 (e.g., processor(s) included in the radio unit 234 or other functional element(s) of the electronic device 210 can permit processing data (e.g., symbols, bits, or chips) for multiplexing/demultiplexing, modulation/demodulation (such as implementing direct and inverse fast Fourier transforms) selection of modulation rates, selection of data packet formats, inter-packet times, and the like.

The codec 282 can operate on information (e.g., data, metadata, signaling, or a combination thereof) in accordance with one or more coding/decoding schemes suitable for communication, at least in part, through the one or more transceivers formed from respective transmitter(s)/receiver(s) 274. In one aspect, such coding/decoding schemes, or related procedure(s), can be retained as a group of one or more computer-accessible instructions (computer-readable instructions, computer-executable instructions, or a combination thereof) in one or more memory devices 264 (referred to as memory 264 in FIG. 2B). In one aspect, to decode received information (e.g., data, metadata, signaling, or a combination thereof), the codec 282 can implement at least one of computation of log-likelihood ratios (LLR) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec 282 can utilize, at least in part, the mux/demux component 278 and mod/demod component 286 to operate in accordance with aspects described herein.

The electronic device 210 can operate in a variety of wireless environments having wireless signals conveyed in different electromagnetic radiation (EM) frequency bands, and thus, the electronic device 210 may be referred to as wireless computing device 210 or wireless device 210. To at least such an end, the communication processing unit 238 can process (code, decode, format, etc.) wireless signals within a set of one or more EM frequency bands (also referred to as frequency bands) comprising one or more of radio frequency (RF) portions of the EM spectrum, microwave portion(s) of the EM spectrum, or infrared (IR) portion of the EM spectrum. In one aspect, the set of one or more frequency bands can include at least one of (i) all or most licensed EM frequency bands, (such as the industrial, scientific, and medical (ISM) bands, including the 2.4 GHz band or the 5 GHz bands); or (ii) all or most unlicensed frequency bands (such as the 60 GHz band) currently available for telecommunication.

As illustrated in FIG. 2B, the electronic device 210 can include a dedicated functionality platform 246 that can provide specific functionality to the electronic device 210. For instance, the dedicated functionality platform 246 can permit the electronic device to operate as one or more of a wireless telephone, a navigation device, a gaming console, a camera, a media reproduction device, or the like. It should be appreciated that the dedicated functionality platform 246 can utilize or otherwise leverage the location sensing unit 248 or information generated therefrom in order to provide one or more functionalities to the electronic device 210. While the dedicated functionality platform 246 is illustrated as an individual functional element, at least a portion of the dedicated functionality platform 246 can be retained in the memory 264 and/or distributed within the electronic device 210. More specifically, in certain embodiments, the dedicated functionality platform 246 can be embodied in or can include a processor, which can be combined with at least one of the I/O interface(s) 244 and one or more software components retained in memory 264 in order to provide functionality to the electronic device 210.

As described herein, in certain implementations, the memory 264 can contain one or more memory elements 228 having information indicative of at least one magnetic footprint associated with a specific environment (e.g., environment 218). It should be appreciated that, in one aspect, availability of the magnetic map(s) 228 in the memory 264 can be optional. In certain implementations, the magnetic map(s) 228 can be embodied in a removable element, such as a subscriber identification module (SIM) card storage, a universal integrated circuit card (UICC) storage, or a removable user identity module (RUIM). The memory 264 also can include a functionality information storage (not depicted) which can include information specific to the location sensing with sub-meter resolution in accordance with aspects of the disclosure. For instance, the memory 264 can contain procedure or methods to determine a location estimate of a ground-truth location based on various wireless signals (e.g., pilot signals) received at the electronic device 210. While not shown, in certain embodiments, one or more memory elements of the memory 264 can include computer-accessible instructions that can be executed by one or more of the functional elements of the electronic device 210 in order to implement at least some of the functionality for location sensing in accordance with aspects of the disclosure. One or more groups of such computer-accessible instructions can embody or can constitute a programming interface that can permit communication of information (e.g., data, metadata, and/or signaling) between functional elements of the electronic device 210 for implementation of such functionality.

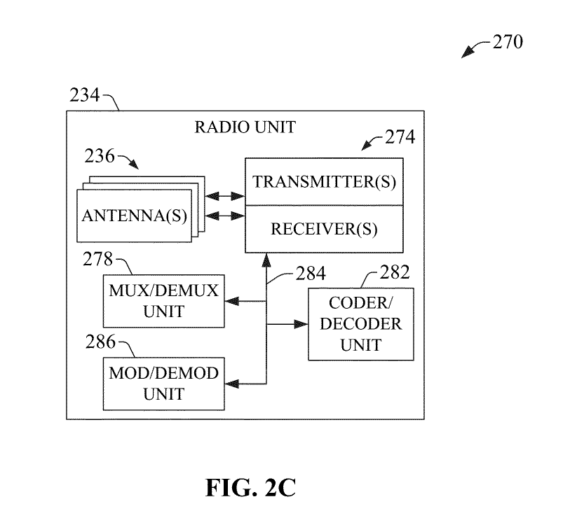

In connection with the mapping stage 110, FIG. 3A presents an example scenario in which measurements of magnetic field are obtained along a path 310 within an indoor environment 300 (e.g., an office environment). The norm (which also may be referred to as the magnitude) |B(r)| of the magnetic field vector B(r) measured at different locations along the path 310 is shown in FIG. 3B for two different measurement instances—conveyed with traces 360 and 370—for the same path 310. From the traces 360 and 370, it can be gleaned that significant spatial variations of magnetic field are present along the path 310, and that the observed spatial distributions 360 and 370 of the magnetic field are consistent over time. Without intending to be bound by theory and/or simulation, the shift that is present between spatial the distributions represented by traces 360 and 370 may be attributed to the disparate translation velocities of the electronic device that probes the magnetic field during the two measurement instances.

With reference to FIG. 1, a second stage of location sensing based at least on a magnetic footprint can include a location determination stage 120, which also may be referred to as a localization stage 120, that permits determination of a location estimate for the ground-truth location of an electronic device based at least on an observed metric representative or indicative of the magnetic field at the ground-truth location. To at least such an end, in one example, implementation of the location determination stage 120 can include performance of one or more magnetic measurements at a ground-truth location, and analysis of the magnetic measurement(s) based at least on a magnetic footprint that is generated or otherwise made available via the magnetic mapping stage 110. In one embodiment, a magnetic sensor (e.g., magnetic sensor 260) integrated into or functionally coupled to an electronic device (e.g., electronic device 210) that performs the location determination stage 120 can performs the magnetic measurements. In one example, the analysis of the magnetic measurement(s) can include a comparison of the one or more magnetic measurements with respect to magnetic metrics representative or otherwise indicative of the magnetic footprint. A location estimate of a ground-truth location can be determined based at least on such a comparison. In one embodiment, a location sensing unit (such as location sensing unit 248) integrated into or functionally coupled to the electronic device that performs the location determination stage 120 can perform such an analysis and/or determine such a location estimate. Numerous techniques can be utilized or otherwise leveraged for comparison of observed magnetic metrics with respect to reference magnetic metrics. For instance, particle filtering and/or pattern matching techniques can be implemented (e.g., developed and/or executed) in order to perform such comparisons and determine a location estimate of the ground-truth location. It should be appreciated that the technique(s) that may be relied on in order to determine a location estimate based on a magnetic footprint of an environment may be agnostic or otherwise independent from the techniques disclosed herein in connection with generation of magnetic field footprint and/or normalization of magnetic information (e.g., reference information and/or observed information). As such, in certain embodiments, the location sensing unit (e.g., location sensing unit 248) can implement at least one of such technique(s), which can be retained in one or more memory devices (e.g., memory 264) integrated into or functionally coupled to the electronic device that performs the location determination stage 120. The techniques can be retained in the memory device(s) as computer-accessible instructions and/or information structures (e.g., data structures, classes, objects, combinations thereof, or the like).

In at least certain embodiments, the disclosure provides adaptive use of magnetic information for location sensing. A magnetic sensor (e.g., a magnetometer) on an electronic device can provide, in a single measurement, three-dimensional (3D) readings representative of a measured magnetic field. Such readings are generally represent the measured magnetic field in a sensor coordinate frame (or sensor coordinate system), and may be referred to as “3D magnetic readings” and are conventionally utilized in two ways: (1) Utilize the norm of the magnetic field at a location, thus reducing a three-dimensional reading to one-dimensional (or scalar) information (e.g., data and/or metadata). In one example, the norm of a magnetic field represents a scalar magnetic metric that is a rotation invariant scalar quantity, insofar as the magnetic sensor is properly calibrated. As such, a process for location estimation that relies on scalar magnetic metrics may not be affected by the manner in which the electronic device is positioned (e.g., device held steadily, device being rotated, a combination thereof, or the like). On the other hand, we reduce the amount of information from three dimensions to one dimension. (2) Utilize a three-dimensional reading by converting it to a global coordinate frame (or global coordinate system). It can be appreciated that utilizing all elements of a 3D reading can preserve the maximum amount of information associated with the measured magnetic field. Yet, in order to convert the 3D readings to the global coordinate frame (which also may be referred to as “Earth coordinate system”), the angular motion of the electronic device (including the yaw, pitch, and roll of the device) may need to be tracked in the mapping stage and localization stage, which may pose challenges in indoor environments. In particular, without intending to be limited by theory and/or modeling, it can be appreciated that tracking the yaw reliably is in itself a challenge due to bias drift of the electronic device's gyroscope (which can be embodied in the inertial sensor 250), for example, and indoor magnetic field distortions. Without intending to be bound by theory and/or modeling, it should be appreciated that yaw estimation errors can lead to divergence of the computational process to generate a satisfactory estimate of the electronic device's location. Therefore, location sensing implementations that rely exclusively on scalar (or one-dimensional (1D)) magnetic metrics can compromise the user experience, whereas those that rely entirely on 3D magnetic metrics can present poor location tracking performance (e.g., convergence to a satisfactory location estimate may be undesirably time-consuming, with convergence time being twice as long as the convergence time in other implementations).

The disclosure recognizes and addresses, in at least certain aspects, the influence of device motion characteristics in satisfactory (e.g., optimal) convergence of a process that determines location estimates in location sensing based on magnetic measurements. To at least such an end, in certain embodiments, the disclosure can permit to utilize or otherwise leverage two-dimensional magnetic data as a magnetic distribution footprint by projecting the magnetic measurements into horizontal plane and vertical plane. It should be appreciated that in order to project the magnetic measurements to the horizontal and vertical planes, the electronic device's pitch and roll angle are needed, instead of yaw, pitch, and roll as typically required to generate a three-dimensional decomposition of a magnetic field vector. It should further be appreciated that yaw angle is the more difficult to obtain than pitch or roll. In scenarios in which linear acceleration that is exerted on an electronic device (e.g., electronic device 210) containing an inertial sensor (e.g., an accelerometer, which can be embodied in the inertial sensor 250) is negligible, the pitch and roll angle of the electronic device can be determined or otherwise obtained via the gravity vector measured by the inertial sensor. As such, in one aspect, as long as the electronic device is positioned steadily while being displaced, the device's pitch and roll can be determined reliably based at least measurements performed by an inertial sensor associated with (e.g., integrated into or otherwise functionally coupled to) the electronic device. It should be appreciated that the misalignment between magnetometer and the accelerometer may be assumed to be known.

Compared with scalar metrics, such as the norm of a magnetic field vector, the two-dimensional vector metric (e.g., the horizontal and vertical projection of the magnetic field vector) can provide more information and can lead to faster convergence of an iterative location estimation process directed to determining or otherwise identifying a satisfactory estimate (e.g., within a tolerance) of a ground truth location. A processing unit or a processor that implements the location estimation process may be referred to as “filter unit” or “filter” in this disclosure. In one example environment, utilization or reliance on scalar magnetic metrics, such as the magnetic norm, can permit a filter unit to converge to a satisfactory location estimate within 19 walking steps, when the filter unit initiates the location estimation process from a fully unknown space (or an unconditioned starting guess for the groun-truth location, for example). In the alternative, for such an environment, utilization or reliance on a vector magnetic metric, such as a pair (or 2-tuple) including the horizontal and vertical projection of the magnetic at a location, the filter unit can converge to a satisfactory location estimate within six walking steps, starting from the same location guess for the ground-truth location. It should be appreciated that compared with three-dimensional vector metrics (e.g., 3D data), two-dimensional vector magnetic metrics (e.g., pairs including the horizontal and vertical projection of the magnetic field at a location) can simplify the determination of a satisfactory location estimate, and can be robust (or algorithmically resilient, for example) to yaw estimation errors.

In at least certain embodiments, the disclosure permits to select the type of information, e.g., scalar magnetic metric or two-dimensional vector magnetic metric, that can be utilized or otherwise relied on during a location stage (e.g., stage 120) based at least on two operational states of the electronic device (e.g., electronic device 210 in FIG. 2A) for which an estimate of the location is being determined or otherwise tracked. Such a selection can be dynamic and can be effected in response to time-dependent changes in at least one of the two operational states. As described herein, in certain embodiments, such as example embodiment 230, the location sensing unit 248 can determine or otherwise generate an estimate of the location of the electronic device 210. Accordingly, in at least certain aspects, the location sensing unit 248 can dynamically select the type of magnetic metric (e.g., scalar metric, two-dimensional vector metric, or three-dimensional vector metric) that is utilized to determine a location estimate. In one example implementation, the location sensing unit 248 can include a metric selection unit (also referred to as “metric selector;” not depicted in FIG. 2B) which can perform such a dynamic selection in accordance with aspects of the disclosure.

Filter State.—

A filter (or filter unit) can be in two states of the location sensing process: (i) converged or (ii) non-converged. In certain embodiments, such as embodiment 230, the location sensing unit 248 can embody or can include the filter. In a scenario in which the filter is in the non-converged state (which also may be referred to as “divergence state” or “divergence”), achieving converge to a satisfactory location estimate of a ground-truth location may be a processing priority. The earlier such a convergence is achieved, the earlier the filter can begin generating or determining satisfactory location estimates of an electronic device, and thereby, in one aspect, being tracking location of the electronic device as the electronic device moves within an environment (e.g., an indoor environment, such as a retailer store, a warehouse, a factory plant, or the like). Accordingly, in one embodiment, in response to the filter being in divergence, the filter can utilize or otherwise leverage two-dimensional (2D) vector magnetic metrics (e.g., horizontal and vertical projections of the magnetic field at a location) in order to achieve faster and more reliable convergence than it may be the case if utilizing or leveraging three-dimensional (3D) vector magnetic metrics. In such a scenario, it may be required or otherwise desired that the electronic device (e.g., electronic device 210) be positioned steadily while the device moves within the environment. As described herein, utilization of 2D vector magnetic metrics can result in the filter converging to a satisfactory location estimate within 3-6 walking steps, which represents a reasonably short transition phase from the non-converged state to the converged state. In one example, an alert (e.g., a message and/or other visual cue, such as “please keep the device steady,” and/or an aural cue) can be rendered at the electronic device in order to alert an end-user to hold the device steadily during the transition phase. For instance, at least one of the I/O interface(s) 244 of the electronic device 210 can render such an alert.

After or upon the filter transitions to a converged state, in which a satisfactory location estimate for a ground-truth location can be available, the filter can switch to utilizing or otherwise leveraging scalar magnetic metrics to generate or otherwise determine a location estimate based at least on magnetic field. After the filter's convergence, the potential location candidates only stay in a small local area, in which the norm or the magnetic field, for example, is sufficiently unique to maintain the tracking accurate. As described herein, norm of the magnetic field is a scalar magnetic metric that is rotation independent, and as such, the end-user can have more freedom to use the electronic device and the performance of the location sensing process may be more robust. It should be understood and appreciated that the state of the filter (e.g., converged or non-converged) embodies or otherwise represents a selection criterion for selecting a specific type of magnetic metric for location sensing. As described herein, such a selection can be responsive to transitioning between the non-converged state and the converged state, and thus can be referred to as dynamic selection.

Device Motion State.—

Movement of an electronic device (such as electronic device 210 in FIG. 2A) can include changes in the device tilt angle. Such changes and related rate of change (e.g., frequency of changes in tilt angle) can be large. In at least certain implementations, the device tilt angle can be determined based at least on the projection of gravity (represented with a vector labeled “g” in FIG. 2A) into a sensor coordinate frame defined by an inertial sensor (e.g., inertial sensor 250, such as an accelerometer or gyroscope) associated with (e.g., integrated into) the device. The rate of change, or temporal variance, of the device tilt angle can be indicative or otherwise representative of the orientational stability of the electronic device. The orientational stability can indicate whether or not the electronic device is being held stably. In one embodiment, in a scenario in which a large rate of change of the device tilt angle, the norm of the magnetic field can be utilized or otherwise leveraged in location sensing in accordance with one or more aspects of this disclosure. In the alternative, in a scenario in which there is little or negligible rate of change of the electronic device tilt angle, a 2D vector magnetic metric (e.g., a pair having the horizontal and vertical projections of a magnetic field) can be utilized in location sensing in accordance with one or more aspects of this disclosure. Utilization of 2D vector magnetic metrics can provide better location sensing performance. It should be understood and appreciated that the positional stability of the electronic device (e.g., stable or non-stable) embodies or otherwise represents a selection criterion for selecting a specific type of magnetic metric for location sensing.

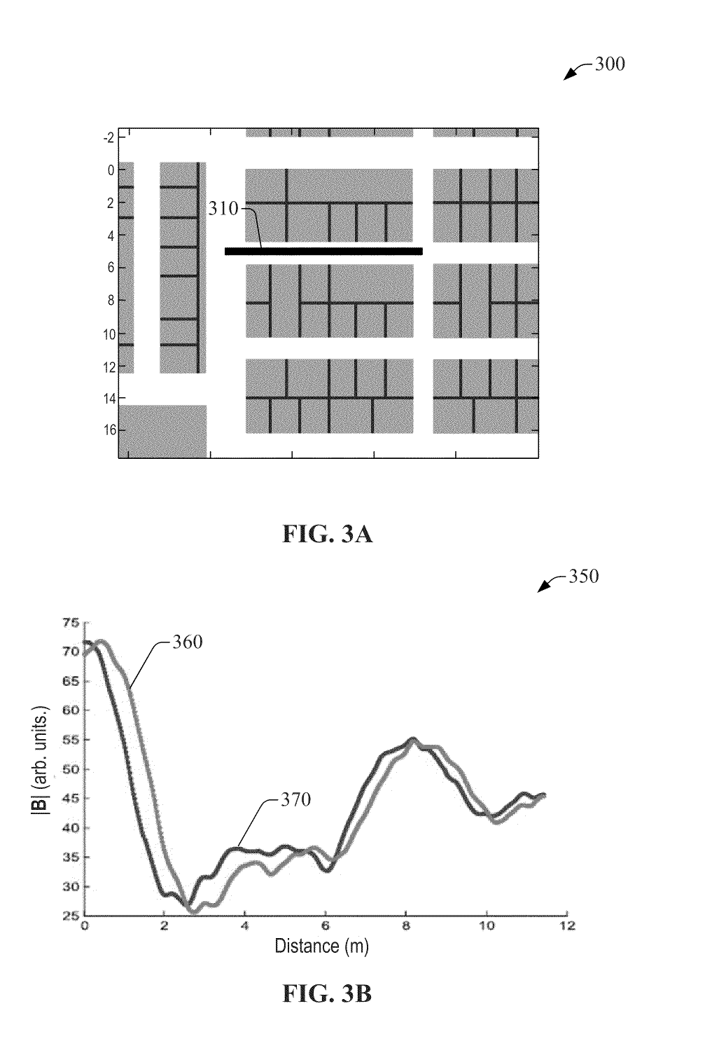

The disclosure also provides, in at least certain embodiments, magnetic maps to address soft-iron distortions in a device's environment. As described herein, location sensing via magnetic measurements can include a magnetic mapping stage (e.g., stage 110 in FIG. 1) at which a magnetic footprint or magnetic signature map is composed or otherwise determined for the indoor magnetic field within an indoor environment (e.g., environment 220 in FIG. 2A). While a magnetic signature map can include spatial variations of magnetic field, this disclosure recognizes that magnetic measurements performed at the same spatial location in different orientations can be different due to at least soft iron distortions. More specifically, yet not exclusively, FIG. 4 presents examples of the norm of measured magnetic field vectors along a trajectory within an example indoor environment (e.g., a retailer store). The example magnetic measurements in FIG. 4 include measurements performed while traversing substantially the same trajectory in opposite directions. As such, two traces 410 and 420 corresponding to respective directions are shown in FIG. 4. The example magnetic measurements shown in traces 410 and 420 are spatially aligned so that their abscissa readings correspond to substantially the same measurement loci in the direction of traversal. In one aspect, it can be gleaned from the measurements that for the first two-meter range, the measurements in each of the respective directions represented by the traces 410 and 420 present substantive differences. In addition, such measurements present similar spatial dependency in the range from about 2 m to about 10 m. Without intending to be bound by theory and/or modeling, it can be concluded that significant soft-iron distortions are present in the measurement range from about 0 m to about 2 m. Accordingly, in one aspect, when the user-device traverses such a segment of the considered trajectory in different directions, the magnetic readings can be substantially different.

Accordingly, in at least certain aspects, the disclosure recognizes and addresses the issue of soft-iron distortions, and the ensuing orientation dependence of magnetic measurements. More specifically, yet not exclusively, the disclosure recognizes and addresses the effect of relative orientation between the magnetic field and a magnetic sensor in composition or otherwise determination of a magnetic signature map. To at least such an end, in certain embodiments, the disclosure can incorporate an orientation variance in magnetic signature maps for location sensing as described herein. In certain aspects, at each location that is surveyed for composition or otherwise determination of a magnetic signature map of an environment (e.g., indoor environment 210), magnetic measurements can be performed two different directions, such as opposite directions. In one example, the orientation variance can be determined by the difference between magnetic metrics obtained from magnetic measurements in the two directions (e.g., a first direction and a second direction opposite to the first direction). More particularly, let Fₖ and Bₖ represent magnetic metrics (scalar or vector metrics) obtained at a location Rₖ in a first direction (e.g., forward direction) and a second direction (e.g., backward direction), respectively. The average magnetic metric at the location Rₖ can be determined according to the following relationship:

μₖ=(Fₖ+Bₖ)/2, Eq. (1)

and the orientation variance at the location Rₖ can be determined as

σk=γ|Fₖ−Bₖ|, Eq. (2)

where γ is a scaling factor, which can be a real number, that can be adjusted as desired, and |•| is a function that yields the magnitude of the argument. Without intending to be bound by theory and/or modeling, it can be appreciated that in certain scenarios (e.g., certain indoor environments), soft-iron distortions can change relatively gradually across space. Therefore, in one aspect, σₖ may be averaged over a spatial window S (e.g., a region spanning about 1 m to 2 m) in order to mitigate or avoid measurement noise in Fₖ and Bₖ.

In a localization stage of location sensing in accordance with aspects of this disclosure, the difference between a current magnetic measurement and available (e.g., pre-recorded) magnetic reference data can be normalized (e.g., weighted) via the orientation variance at a specific position of a user device (e.g., electronic device 210). Therefore, in areas having substantive soft iron distortions, the different magnetic measurements due to the user-user traversing an environment in different directions (e.g., different yaw) may cause a lesser divergence of a tracking processing resource (such as a processor or track filter unit).

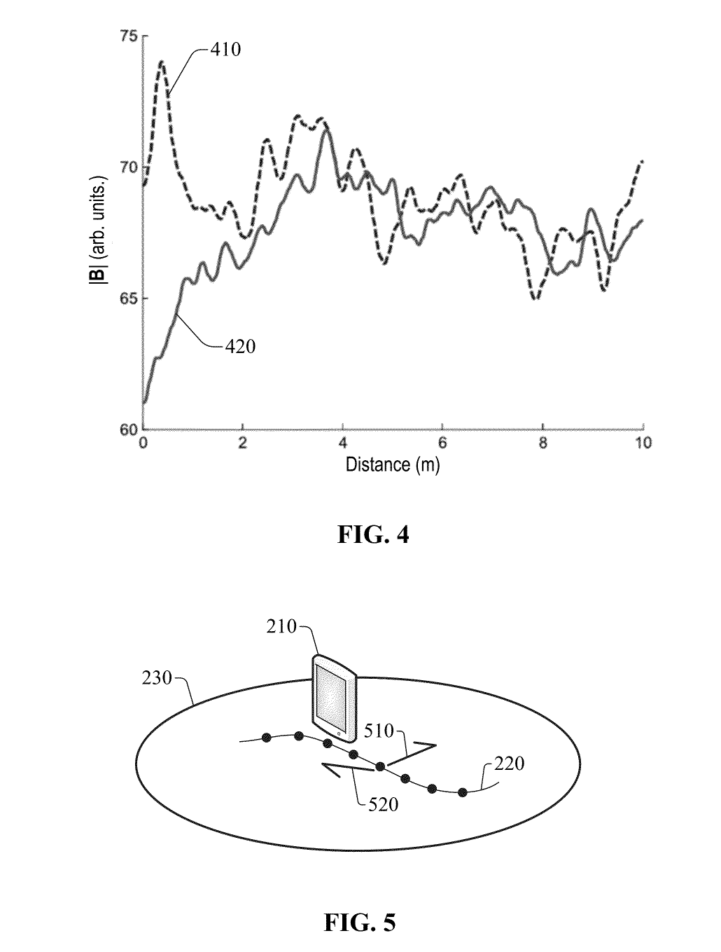

FIG. 5 illustrates an example of an operational environment in accordance with one or more aspects of the disclosure. The electronic device 210 can traverse the trajectory 220 within the indoor environment 230 (e.g., a warehouse, a retailer store, or the like) and at each location of a set of predetermined locations, represented with a black dot, the electronic device 210 can perform magnetic measurements oriented in a first direction 510 and a second direction 520. As described herein, in one example, the set of predetermined locations can form or otherwise constitute a dense grid of locations that permit generating a magnetic footprint for the indoor environment 230. In one implementation, based at least on some or each of such measurements, the average magnetic metric (e.g., μₖ) and/or the orientation variance (σₖ) described herein can be determined.

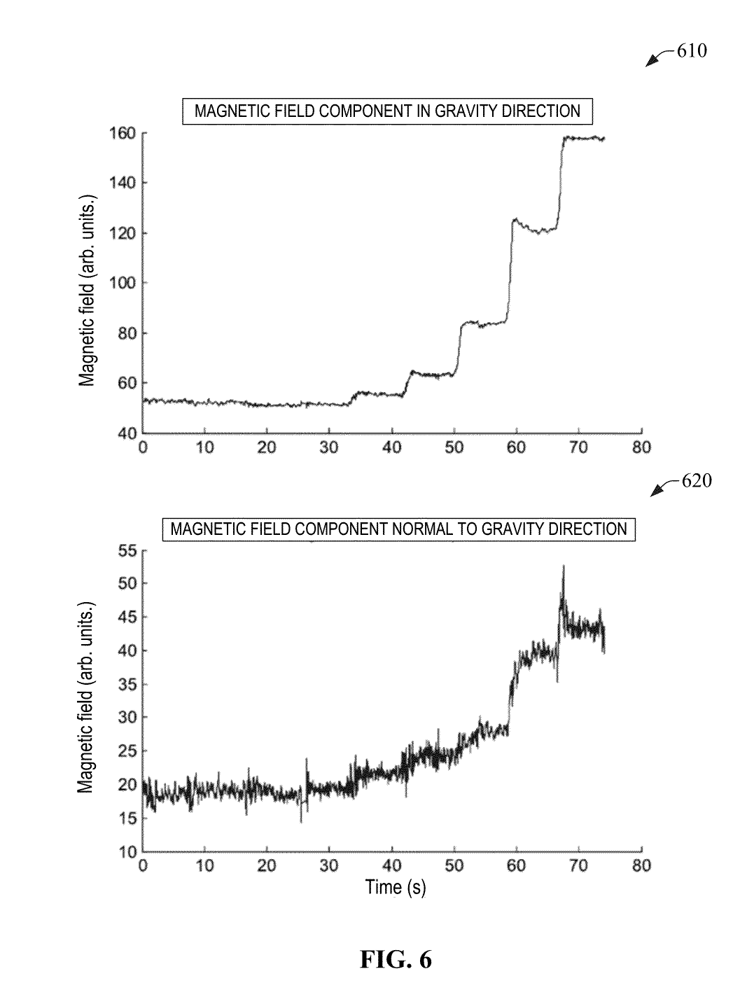

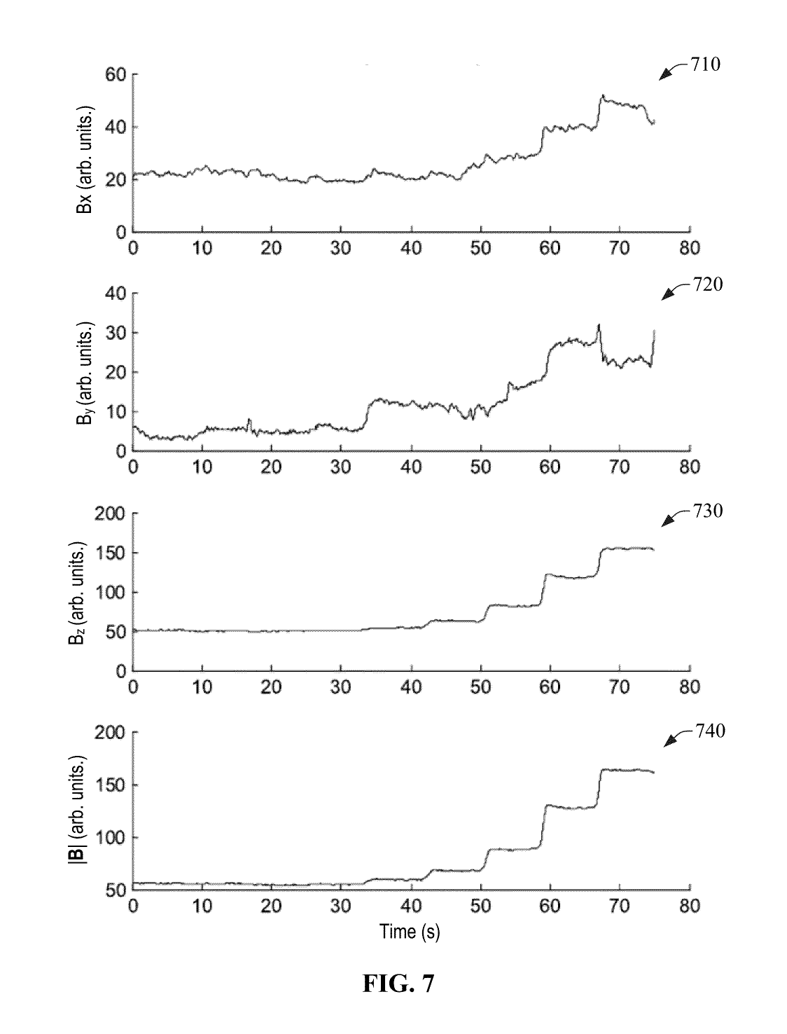

The disclosure also can contemplate other directionality effects and, in at least certain embodiments, it can provide normalization of magnetic measurement to address height differences. FIGS. 6-7 illustrate metrics representative of magnetic field as a function of elevation at substantially the same in-plane location within an example indoor environment. FIG. 6 illustrates two of such metrics in respective charts 610 and 620 representing, respectively, the component of magnetic field vector along the direction of the gravity vector and the component on the x-axis or y-axis, or a combination thereof, of the same magnetic field vector. The component in the direction normal to the direction of the gravity vector can be referred to as “horizontal” component. FIG. 7 illustrates four of such metrics charts 710, 720, and 730 representing, respectively, the x-axis, y-axis, and z-axis components of the magnetic field vector. Chart 740 represents the norm of the magnetic field vector. In the illustrated charts, the elevation of a magnetic sensor associated with (e.g. integrated into) an electronic device decreases as time progresses. As such, the abscissa is shown as measurement time, which represents elevation. As gleaned from the measurements, magnetic field within the example indoor environment can vary significantly as a function of elevation.

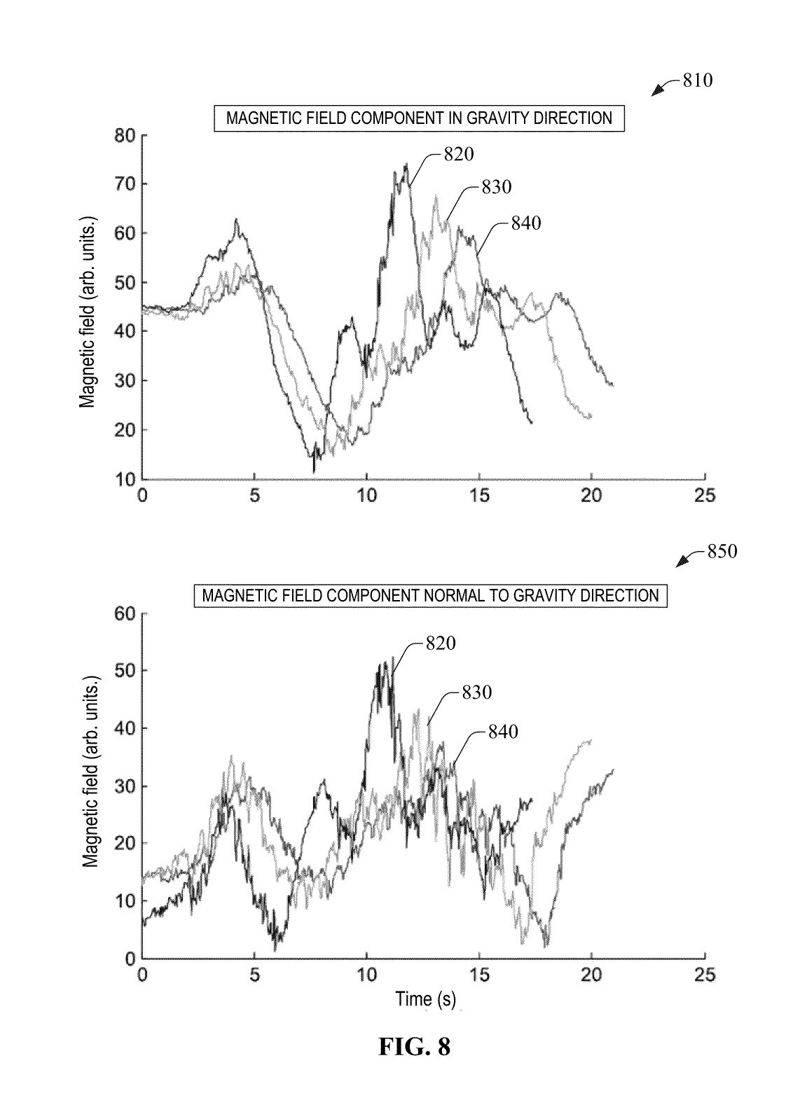

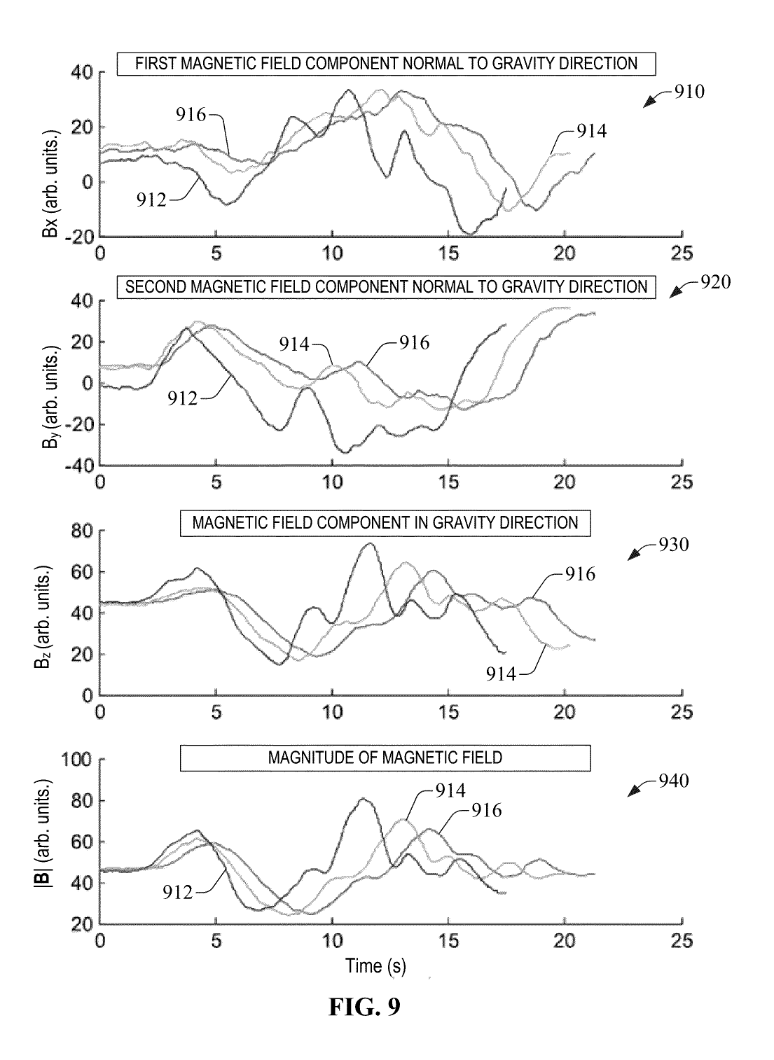

In addition, FIG. 8 illustrates metrics representative of magnetic field as a function of time along a trajectory at substantially constant height (or at a substantial isoheight). In example chart 810, the component of the magnetic field vector along the gravity vector is shown as function of time for three different heights in respective traces 820, 830, and 840. In addition, chart 850 presents the component of the magnetic field vector along an axis normal to the direction of the gravity vector as function of time for the three heights considered in the measurement shown in chart 810. Therefore, each of the traces 860, 870, and 880 correspond to a specific height. As it can be gleaned from charts 810 and 850, although the absolute measurements are different at different height, the specific changes of the magnetic metric (which also may be referred to as pattern of changes) along the considered trajectory remains substantially consistently comparable. Without intending to be bound by theory and/or modeling, it should be recognized that the shift in time between the different traces in an illustrated chart is essentially due to different velocity at which the considered trajectory is traversed. Accordingly, in one aspect, such a shift can be addressed via time alignment. Similarly, FIG. 9 also illustrates metrics representative of magnetic field as a function of time along a trajectory at substantially constant height (or at a substantial isoheight). Each of the traces 912, 914, and 916 illustrated at each of panels 910, 920, 930, and 940 corresponds to a specific height (each an isoheight). From such traces, it can be gleaned that although the absolute measurements are different at different height, the specific changes of the magnetic metric (which also may be referred to as pattern of changes) along the considered trajectory remains substantially consistently comparable.

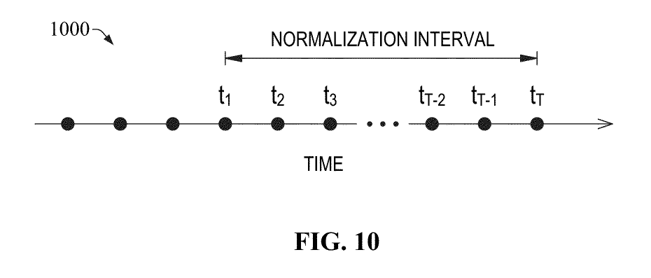

In at least certain aspects, the disclosure addresses the impact of different user-device elevation in magnetic measurements. To at least such an end, in certain embodiments, the disclosure can permit utilizing or otherwise leveraging a window of normalized magnetic measurements to address (e.g., mitigate) the effect of variability of device height on a localization stage in the location sensing in accordance with aspects of this disclosure. More specifically, in one example, a normalization time interval spanning a period ΔT can be identified or otherwise determined. A group of current magnetic metrics (either scalar or vector) within the normalization time interval can be represented as T-tuple, with T a natural number greater than or equal to 1 representing the number of measurements performed during the normalization time interval: Y=[Y₁, Y₂, . . . , Y_{T}]. Such current magnetic metrics can be determined from a group of current magnetic measurements associated with a current location stage, such as location tracking in a trajectory. In one aspect, as illustrated in FIG. 10, the normalization time interval can include a contemporaneous instant t_{T} in which a magnetic measurement is performed at a location R_{T}, and a group of historical instants {t₁, t₂, . . . , t_{T-1}} in which respective measurements of magnetic field are performed at respective locations {R₁, R₂, . . . R_{T}}. Similarly, a group of T reference measurements associated with a magnetic map (or magnetic footprint) and spanning a period ΔT also can be represented as a T-tuple X=[X₁, X₂, . . . , X_{T}], and can be utilized in the normalization of the of the observed Y T-tuple. In one example, the current measurements contained in the localization stage (e.g., the current measurements of magnetic field in a trajectory for which location of an electronic device is tracked) and represented by the T-tuple Y can be normalized based on the relative values between X₁, X_{T}, and Y₁ and Y_{T} as follows:

$${\tilde{Y}}_{J} = {Y}_{J} min [ δ , \frac{{X}_{T} - {X}_{1}}{{Y}_{T} - {Y}_{1}} ] + {X}_{1} - {Y}_{1} min [ δ , \frac{{X}_{T} - {X}_{1}}{{Y}_{T} - {Y}_{1}} ] , \qquad Eq . ( 3 )$$

where \tilde{Y}_{J} is the normalized value of component J of the T-tuple Y, with J=1, 2, . . . T, and where σ is a positive real number that can bound the coefficient (also referred to as scaling factor) that weights the value of Y_{J} and Y₁ in the example normalization. In addition, in Eq. (3), the function min(a,b) is valued at the minimum of a and b, which are numbers in the real domain. It can be appreciated that in the example normalization in Eq. (3), a current measurement is linearly scaled in a manner that the initial current metric Y₁ and ending current metric Y_{T} within the normalization time interval can have the same respective values as the reference metrics X₁ and X_{T}. As a result, without intending to be bound by theory and/or modeling, the absolute measurement differences between current measurements and reference measurements may not affect the performance of a computing resource (e.g., such as processor and/or component) that can compute or otherwise determine a location estimate of a ground-truth location. In addition, any higher order variations within the normalization time interval ΔT can be preserved so that the pattern similarity between current measurements and reference measurements can be utilized or otherwise leveraged. Other normalization schemes beyond linear scaling also can be contemplated in this disclosure.

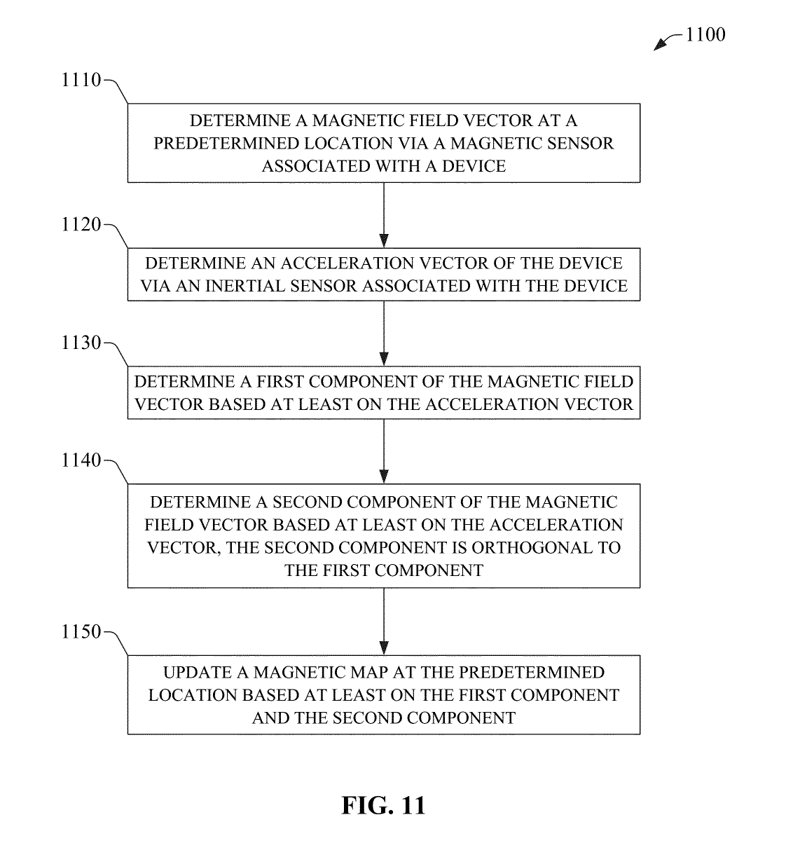

In view of the aspects described herein, example techniques that can be implemented in accordance with this disclosure can be better appreciated with reference to the diagrams in FIGS. 11-13. For purposes of simplicity of explanation, the example methods disclosed herein are presented and described as a series of blocks (with each block representing an action or an operation in a method, for example). However, it is to be understood and appreciated that the disclosed methods are not limited by the order of blocks and associated actions or operations, as some blocks may occur in different orders and/or concurrently with other blocks from that shown and described herein. For example, the various methods or processes of the disclosure can be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes can be implemented in combination with each other, to accomplish one or more features or advantages described herein.

It should be appreciated that the methods of the disclosure can be retained on an article of manufacture, or computer-readable storage medium, to permit or facilitate transporting and transferring such methods to a computing device (e.g., a desktop computer; a mobile computer, such as a tablet computer or a smartphone; a gaming console, a mobile telephone; a blade computer; a programmable logic controller, and the like) for execution, and thus implementation, by a processor of the computing device or for storage in a memory thereof or functionally coupled thereto. In one aspect, one or more processors, such as processor(s) that implement (e.g., execute) one or more of the disclosed methods, can be employed to execute code instructions retained in a memory, or any computer- or machine-readable medium, to implement the one or more methods. The code instructions can provide a computer-executable or machine-executable framework to implement the methods described herein.

FIG. 11 illustrates an example of a method 1100 for magnetic mapping in accordance with one or more aspects of the disclosure. A computing device that can implement the subject example method can include an electronic device (e.g., electronic device 210 or computing device 1410) including one or more magnetic sensors, one or more inertial sensors, one or more memory devices, and one or more processors functionally coupled to at least one of the memory device(s). The one or more memory devices can have computer-accessible instructions that, when executed, can permit the electronic device to carry out the subject example method. At block 1110, a magnetic field vector can be determined or otherwise accessed at a predetermined location via a magnetic sensor associated with an electronic device. In one example, the magnetic sensor can be embodied in or can include a solid-state three-axis magnetometer, which can be integrated into the electronic device. As described herein (see, e.g., FIG. 2 and/or FIGS. 3A-3B) the predetermined location may constitute a path within an indoor environment, such as a retailer store, a warehouse, a library, and the like). At block 1120, an acceleration vector of the electronic device can be determined via an inertial sensor (e.g., a solid-state accelerometer or gyroscope) integrated into or otherwise associated with the electronic device. At block 1130, a first component of the magnetic field vector can be determined or otherwise accessed based at least on the acceleration vector. In one implementation, the first component can be determined by projecting the magnetic field vector onto a predetermined or otherwise desired direction in space. For example, as described herein, the first component can be the projection of the magnetic field vector onto an axis parallel to the gravity vector in an earth coordinate system. At block 1140, a second component of the magnetic field vector can be determined or otherwise accessed based at least on the acceleration vector. The second component can be orthogonal to the first component. As such, as described herein, the second component can be the projection of the magnetic field vector onto an axis orthogonal to the gravity vector in the earth coordinate system. In certain embodiments, determining at least one of the first component of the magnetic field vector or the second component of the magnetic field vector can include determining a pitch of the electronic device based at least on the acceleration vector, and determining a roll of the electronic device based at least on the acceleration vector. In addition, the pitch and roll that are so determined can permit projecting the magnetic field vector onto at least one plane in an earth coordinate system. In addition or in the alternative, in one example, the magnetic sensor can be oriented in a first direction, and the subject example method can include determining a second magnetic field vector at substantially the predetermined location via the magnetic sensor oriented in a second direction different from the first direction. In one aspect, the subject example method can include determining a second acceleration vector of the electronic device at substantially the predetermined location via the inertial sensor associated with the electronic device, wherein the electronic device is oriented in the second direction. At block 1150, a magnetic map can be updated at the predetermined location based at least on the first component of the magnetic field vector and the second component of the magnetic field vector. In one example, the magnetic map can be retained in at least one memory element of the memory device(s) and can be updated (e.g., generated or revised) locally at the electronic device. In addition or in the alternative, the electronic device can communicate information indicative of the such first and second components to a network, or a component thereof, that can retain magnetic maps in accordance with aspects of this disclosure.

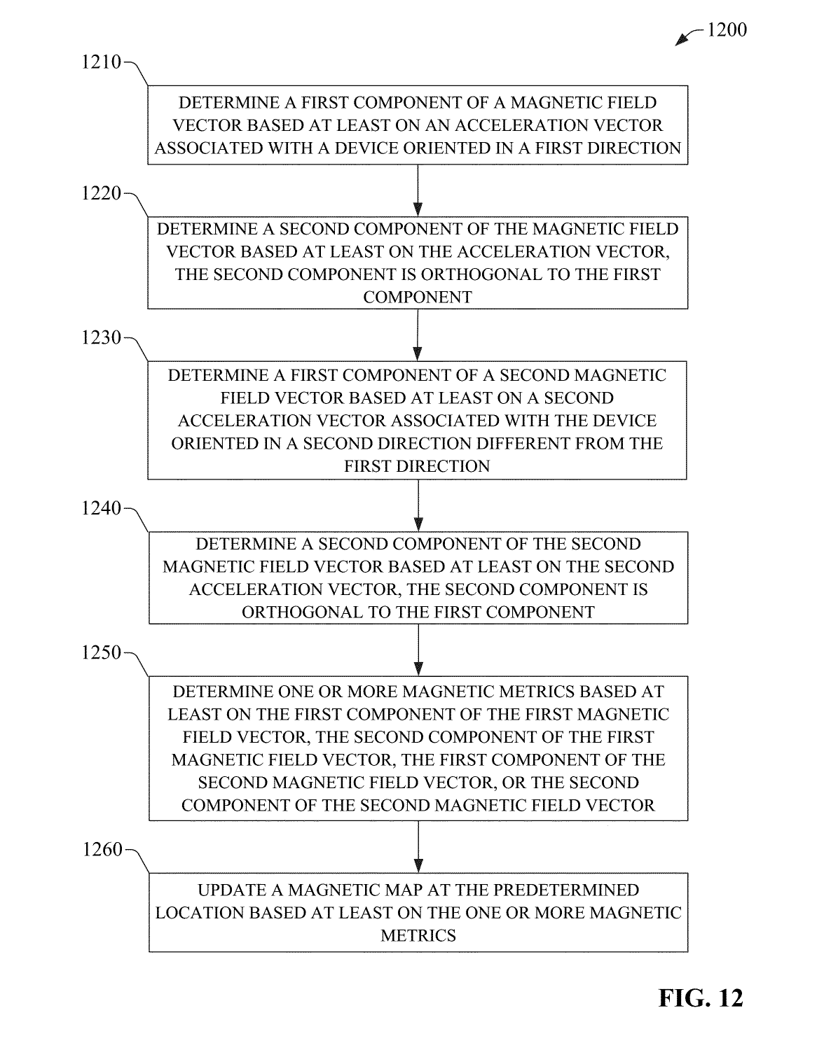

FIG. 12 illustrates another example of a method 1200 for magnetic mapping in accordance with one or more aspects of the disclosure. A computing device that can implement the subject example method can include an electronic device (e.g., electronic device 210 or computing device 1410) including one or more magnetic sensors, one or more inertial sensors, one or more memory devices, and one or more processors functionally coupled to at least one of the memory device(s). The one or more memory devices can have computer-accessible instructions that, when executed, can permit the electronic device to carry out the subject example method. At block 1210, a first component of a magnetic field vector can be determined based at least on an acceleration vector associated with an electronic device oriented in a first direction. In certain implementations, as described herein, the acceleration vector can mainly include the gravity vector without components arising from motion of the electronic device (e.g., linear acceleration of the electronic device may be negligible). In one implementation, the first component can be determined by projecting the magnetic field vector onto a predetermined or otherwise desired direction in space. For example, as described herein, the first component can be the projection of the magnetic field vector onto an axis parallel to the gravity vector in an earth coordinate system. At block 1220, a second component of the magnetic field vector can be determined based at least on the acceleration vector. In one aspect, the second component can be orthogonal to the first component. As such, in the example implementation referenced in block 1210, the second component can be the projection of the magnetic field vector onto an axis orthogonal to the gravity vector in the earth coordinate system.

At blocks 1230 and 1240, the operations in blocks 1210 and 120 can be respectively substantially reiterated with the electronic device oriented in a second direction different from the first direction. As described herein, the first direction and the second direction can form a specific angle, and in certain implementations, the second direction can be opposite to the first direction. More specifically, at block 1230, a first component of a second magnetic field vector can be determined based at least on a second acceleration vector associated with the electronic device oriented in the second direction. Similarly, at block 1240, a second component of the second magnetic field vector can be determined based at least on the second acceleration vector.

As described herein, the various components of the first and second magnetic field vectors can be processed in order to introduce directionality information into a magnetic footprint (or magnetic map), which can permit leveraging soft-iron distortions for location sensing. In one aspect, at block 1250, at least one magnetic metric (e.g., a scalar or vector metric) can be determined based at least on the first component of the first magnetic field vector, the second component of the first magnetic field vector, the first component of the second magnetic field vector, or the second component of the second magnetic field vector. In one example, determining the at least one magnetic metric can include determining an average of the first component of the first magnetic field vector and the first component of the second magnetic field vector, and determining a second average of the second component of the first magnetic field vector and the second component of the second magnetic field vector. In addition or in the alternative, determining the at least one magnetic metric can include determining a weighted magnitude of a difference between the first component of the first magnetic field vector and the first component of the second magnetic field vector, and determining a second weighted magnitude of a difference between the second component of the first magnetic field vector and the second component of the second magnetic field vector.

At block 1260, a magnetic map can be updated at the predetermined location based at least on the one or more magnetic metrics. In one example, updating the magnetic map at the predetermined location can include associating the predetermined location to the average, the second average, the weighted difference, and the second weighted difference.

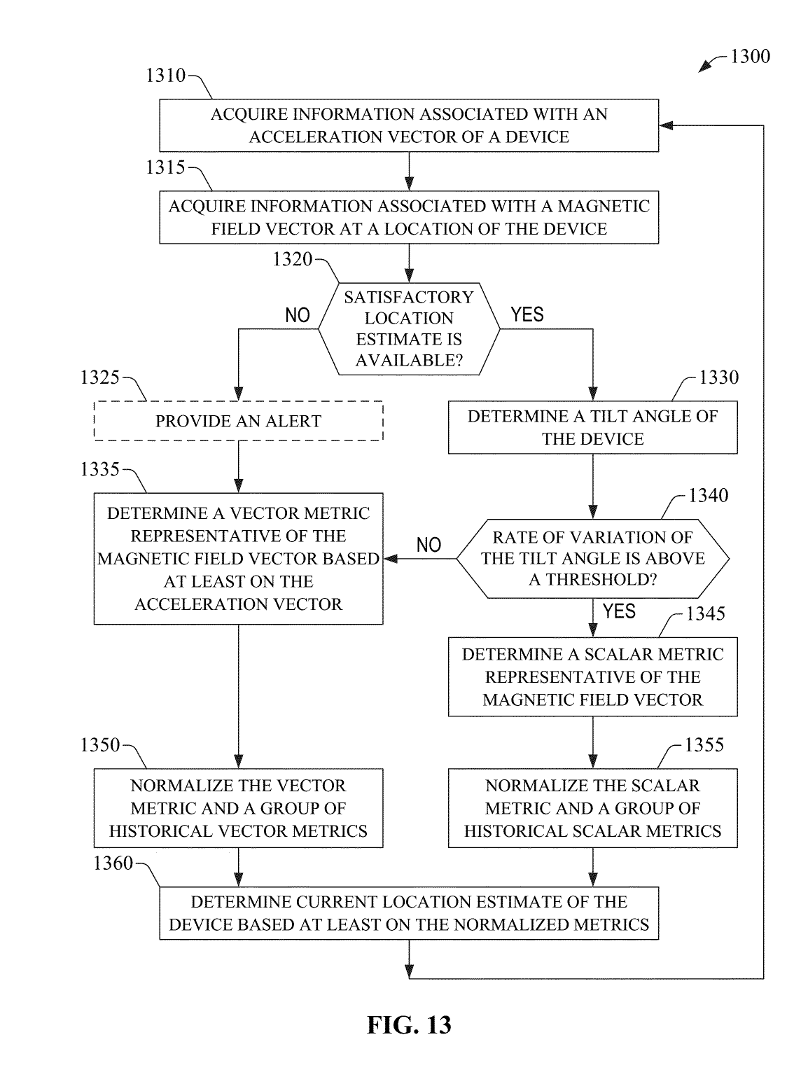

FIG. 13 presents a flowchart of an example method 1300 for location sensing in accordance with one or more aspects of the disclosure. A computing device that can implement the subject example method can include an electronic device (e.g., electronic device 210 or computing device 1410) including one or more magnetic sensors, one or more inertial sensors, one or more memory devices, and one or more processors functionally coupled to at least one of the memory device(s). The one or more memory devices can have computer-accessible instructions that, when executed, can permit the electronic device to carry out the subject example method. In addition or in the alternative, the computing device can be remote to an electronic device including magnetic sensors and inertial sensors that can provide magnetic measurement and motion measurement, such as acceleration measurements and/or device orientation measurements. The computing device can receive or otherwise access information from such an electronic device and can perform the subject example method in part or in its entirety. At block 1310, information associated with (e.g., representative or indicative of) an acceleration vector associated with an electronic device can be acquired. An inertial sensor integrated into or functionally coupled to the electronic device can probe the acceleration of the device and can generate at least a portion of the information. A processor integrated or functionally coupled to the electronic device can acquire at least a portion of the information generated via the inertial sensor. The information that is acquired can be digital, analogic, or a combination thereof. At block 1315, information associated with a magnetic field vector at a location of the electronic device can be acquired. As described herein, a magnetic sensor (such as a three-axis magnetometer) that is integrated into or functionally coupled to the electronic device can probe the magnetic field and can generate at least a portion of the information. In one example, a processor integrated or functionally coupled to the electronic device can acquire at least a portion of the information generated via the magnetic sensor. The information that is acquired can be digital, analogic, or a combination thereof.

At block 1320, it can be determined if an estimate of the location of the electronic device is available with a satisfactory accuracy. For instance, a computational resource (e.g., a processor or a component) can determine such a location estimate iteratively based on magnetic and inertial information. As such, in response to an iterative computing cycle converging within a satisfactory or otherwise desired accuracy, the location estimated determined in such a manner may be provided as a satisfactory location estimate for the electronic device. As illustrated, based at least on the outcome of block 1320, the subject example method 1300 can proceed in at least two operational pathways. In a first operational pathway, in response to ascertaining that a satisfactory location estimate is unavailable, an alert may be provided at block 1325. In one example, the alert can include sounds, images, a combination thereof, or the like, and can be rendered (e.g., displayed, played-back, or the like) at the electronic device. In certain embodiments, providing the alert may be optional. In addition, at block 1335, a vector metric representative of the magnetic field vector can be determined based at least on the acceleration vector. At block 1350, the vector metric and a group of historical vector metrics can be normalized. As described herein, in one example, such metrics can be normalized according to a linear scaling.

In a second operational pathway, in response to ascertaining that a satisfactory location estimate is available, a tilt angle of the electronic device can be determined at block 1330. In one implementation, the tilt angle can be determined based at least on the acceleration vector of the electronic device. Based at least on the tilt angle, at block 1340, it can be determined if a rate of variation of the tilt angle is above a threshold. In response to ascertaining that the tilt angle is above the threshold, flow of the subject example method can proceed to block 1355, at which a vector metric representative of the magnetic field vector can be determined. As described herein, the vector metric can be determined based at least on the acceleration vector. In addition, in one example, the flow can further proceed to block 1350, at which the vector metric (e.g., a two-dimensional vector) and a group of historical vector metrics can be normalized as described herein. In the alternative, in response to ascertaining that the rate of variation of the tilt angle is not above the threshold, a scalar metric representative of the magnetic field vector can be determined. For instance, the scalar metric can be the norm of the magnetic field vector. The norm may be determined in a sensor coordinate system, relying on each of the three measurements provide by a three-axis magnetometer. The norm also may be determined in the earth coordinate system. At block 1355, the scalar metric determined at block 1345 and a group of historical scalar metrics can be normalized.

As illustrated, either operational pathway that can be implemented in response to the outcome of the determination at block 1320 can proceed to block 1360, at which a current location estimate of the electronic device can be determined based at least on the normalized metrics of either block 1350 or 1355.

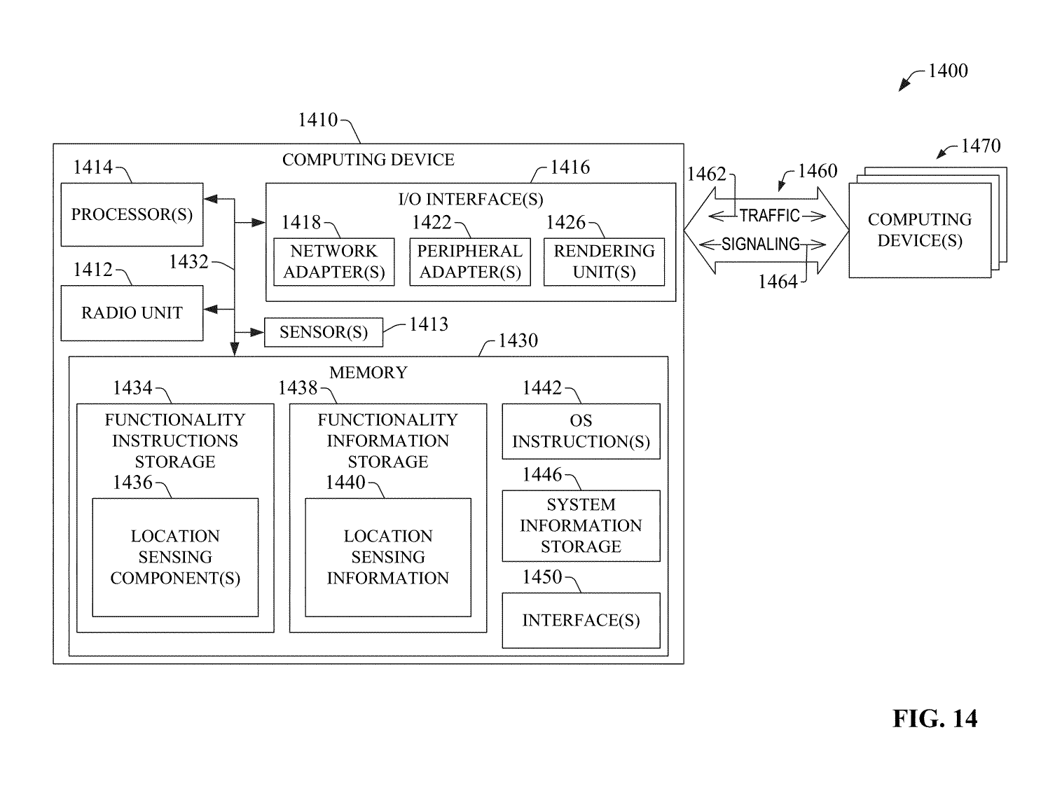

FIG. 14 illustrates an example of a computational environment 1400 for location sensing in accordance with one or more aspects of the disclosure. The example computational environment 1400 is only illustrative and is not intended to suggest or otherwise convey any limitation as to the scope of use or functionality of such computational environments' architecture. In addition, the computational environment 1400 should not be interpreted as having any dependency or requirement relating to any one or combination of components illustrated in this example computational environment. The illustrative computational environment 1400 can embody or can comprise the electronic device 210 (also referred to as computing device 110) and/or functional elements of at least one of the network(s) 220.

The computational environment 1400 represents an example of a software implementation of the various aspects or features of the disclosure in which the processing or execution of operations described in connection with the location sensing disclosed herein can be performed in response to execution of one or more software components at the computing device 1410. It should be appreciated that the one or more software components can render the computing device 1410, or any other computing device that contains such components, a particular machine for location sensing in accordance with aspects described herein, among other functional purposes. A software component can be embodied in or can comprise one or more computer-accessible instructions, e.g., computer-readable and/or computer-executable instructions. In one scenario, for example, at least a portion of the computer-accessible instructions can embody one or more of the example techniques presented in FIGS. 11-13 and described herein. For instance, to embody one such method, at least the portion of the computer-accessible instructions can be persisted (e.g., stored, made available, or stored and made available) in a computer storage non-transitory medium and executed by one or more processors. The one or more computer-accessible instructions that embody a software component can assembled into one or more program modules, for example, that can be compiled, linked, and/or executed at the computing device 1410 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 1410 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with location sensing in accordance with features described herein can comprise personal computers; server computers; laptop devices; handheld computing devices, such as mobile tablets; wearable computing devices; and multiprocessor systems. Additional examples can include set top boxes, programmable consumer electronics, network PCs, minicomputers, mainframe computers, blade computers, programmable logic controllers, distributed computing environments that comprise any of the above systems or devices, and the like.

As illustrated, the computing device 1410 can comprise one or more sensors 1413, one or more processors 1414, one or more input/output (I/O) interfaces 1416, a memory 1430, and a bus architecture 1432 (also termed bus 1432) that functionally couples various functional elements of the computing device 1410. The bus 1432 can include at least one of a system bus, a memory bus, an address bus, or a message bus, and can permit exchange of information (data, metadata, and/or signaling) between the processor(s) 1414, the I/O interface(s) 1416, and/or the memory 1430, or respective functional element therein. In certain scenarios, the bus 1432 in conjunction with one or more internal programming interfaces 1450 (also referred to as interface(s) 1450) can permit such exchange of information. In scenarios in which processor(s) 1414 include multiple processors, the computing device 1410 can utilize parallel computing.

The I/O interface(s) 1416 can permit or otherwise facilitate communication of information between the computing device and an external device, such as another computing device, such as a network element (e.g., a router, a gateway, a server, or the like). Such communication can include direct communication or indirect communication, such as exchange of information between the computing device 1410 and the external device via a network or elements thereof. As illustrated, the I/O interface(s) 1416 can comprise one or more of network adapter(s) 1418, peripheral adapter(s) 1422, and rendering unit(s) 1426. Such adapter(s) can permit or facilitate connectivity between the external device and one or more of the processor(s) 1414 or the memory 1430. In one aspect, at least one of the network adapter(s) 1418 can couple functionally the computing device 1410 to one or more computing devices 1470 via one or more traffic and signaling pipes 1460 that can permit or facilitate exchange of traffic 1462 and signaling 1464 between the computing device 1410 and the one or more computing devices 1470. Such network coupling provided at least in part by the at least one of the network adapter(s) 1418 can be implemented in a wired environment, a wireless environment, or both. The information that is communicated by the at least one network adapter can result from implementation of one or more operations in a method of the disclosure. Such output can be any form of visual representation, including, but not limited to, textual, graphical, animation, audio, tactile, and the like. In certain scenarios, each of the computing device(s) 770 can have substantially the same architecture as the computing device 1410. In addition or in the alternative, the rendering unit(s) 1426 can include functional elements (e.g., lights, such as light-emitting diodes; a display, such as liquid crystal display (LCD), combinations thereof, or the like) that can permit control of the operation of the computing device 1410, or can permit conveying or revealing operational conditions of the computing device 1410. For instance, the at least one of the rendering unit(s) 1426 can convey an alert indicative or otherwise representative of unstable handing of the computing device 1410 in accordance with aspects described herein.

In one aspect, the bus 1432 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, Universal Serial Bus (USB), and the like. The bus 1432, and all buses described herein can be implemented over a wired or wireless network connection and each of the subsystems, including the processor(s) 1414, the memory 1430 and memory elements therein, and the I/O interface(s) 1416 can be contained within one or more remote computing devices 1470 at physically separate locations, connected through buses of this form, in effect implementing a fully distributed system.

The computing device 1410 can comprise a variety of computer-readable media. Computer readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 1410, and can comprise, for example, both volatile and non-volatile media, and removable and/or non-removable media. In one aspect, the memory 1430 can comprise computer-readable media in the form of volatile memory, such as random access memory (RAM), and/or non-volatile memory, such as read only memory (ROM).

The memory 1430 can comprise functionality instructions storage 1434 and functionality information storage 1438. The functionality instructions storage 1434 can comprise computer-accessible instructions that, in response to execution (by at least one of the processor(s) 1414), can implement one or more of the functionalities of the disclosure. The computer-accessible instructions can embody or can comprise one or more software components illustrated as location sensing component(s) 1436. In one scenario, execution of at least one component of the location sensing component(s) 1436 can implement one or more of the example methods 1100 through 1300. For instance, such execution can cause a processor that executes the at least one component to carry out a disclosed example method. It should be appreciated that, in one aspect, a processor of the processor(s) 1414 that executes at least one of the location sensing component(s) 1436 can retrieve information from or retain information in a memory element 1440 in the functionality information storage 1438 in order to operate in accordance with the functionality programmed or otherwise configured by the location sensing component(s) 1436. Such information can include at least one of code instructions, information structures, or the like. For instance, the location sensing information 1440 can embody or can include one or more techniques for determining a location estimate based on magnetic measurements and a magnetic footprint. In addition, the location sensing information 1440 also can embody or can include selection criteria for selecting a type of magnetic metric to be utilized or otherwise leveraged to determine a location estimate of the computing device 1410. Further, the location sensing information 1440 also can embody or can include one or more magnetic mappings for one or more respective environments.

In addition, at least one of the one or more interfaces 1450 (e.g., application programming interface(s)) can permit or facilitate communication of information between two or more components within the functionality instructions storage 1434. The information that is communicated by the at least one interface can result from implementation of one or more operations in a method of the disclosure. In certain embodiments, one or more of the functionality instructions storage 1434 and the functionality information storage 1438 can be embodied in or can comprise removable/non-removable, and/or volatile/non-volatile computer storage media.

At least a portion of at least one of the location sensing component(s) 1436 or location sensing information 1440 can program or otherwise configure one or more of the processors 1414 to operate at least in accordance with the functionality described herein. In certain embodiments, the location sensing component(s) 1436 contained in the functionality instruction(s) storage 1434 can embody or can constitute the location sensing unit 248. One or more of the processor(s) 1414 can execute or otherwise implement at least one of such components and leverage at least a portion of the information in the storage 1438 in order to provide location sensing in accordance with one or more aspects described herein. In other embodiments, at least one of the processor(s) 1414 and the location sensing component(s) 1436 can embody or can constitute the location sensing unit 248. The at least one processor can execute or otherwise implement at least one of such components and leverage at least a portion of the information in the storage 1438 in order to provide location sensing in accordance with one or more aspects described herein.

In addition to the location sensing component(s) 1436 and the location sensing information 1440, the computing device 410 can utilize or otherwise rely on one or more sensors 1413 in order to provide location sensing based on the magnetic measurements in accordance with the disclosure. In one embodiment, at least one of the sensor(s) 1413 can be embodied in or can include an inertial sensor (such as the inertial sensor 250), which can measure acceleration (either linear or angular) and/or determine orientation (e.g., yaw, pitch, and/or roll) of the computing device 1410. In addition, at least one second sensor of the sensor(s) 1413 can be embodied in or can include a magnetic sensor (such as the magnetic sensor 260), which can probe or otherwise measure the magnetic field at a location of the computing device 1410.

It should be appreciated that, in certain scenarios, the functionality instruction(s) storage 1434 can embody or can comprise a computer-readable non-transitory storage medium having computer-accessible instructions that, in response to execution, cause at least one processor (e.g., one or more of processor(s) 1414) to perform a group of operations comprising the operations or blocks described in connection with the disclosed methods.

In addition, the memory 1430 can comprise computer-accessible instructions and information (e.g., data and/or metadata) that permit or facilitate operation and/or administration (e.g., upgrades, software installation, any other configuration, or the like) of the computing device 1410. Accordingly, as illustrated, the memory 1430 can comprise a memory element 1442 (labeled OS instruction(s) 1442) that contains one or more program modules that embody or include one or more OSs, such as Windows operating system, Unix, Linux, Symbian, Android, Chromium, and substantially any OS suitable for mobile computing devices or tethered computing devices. In one aspect, the operational and/or architecture complexity of the computing device 1410 can dictate a suitable OS. The memory 1430 also comprises a system information storage 1446 having data and/or metadata that permits or facilitate operation and/or administration of the computing device 1410. Elements of the OS instruction(s) 1442 and the system information storage 1446 can be accessible or can be operated on by at least one of the processor(s) 1414.

It should be recognized that while the functionality instructions storage 1434 and other executable program components, such as the operating system instruction(s) 1442, are illustrated herein as discrete blocks, such software components can reside at various times in different memory components of the computing device 1410, and can be executed by at least one of the processor(s) 1414. In certain scenarios, an implementation of the location sensing component(s) 1436 can be retained on or transmitted across some form of computer readable media.

The computing device 1410 and/or one of the computing device(s) 1470 can include a power supply (not shown), which can power up components or functional elements within such devices. The power supply can be a rechargeable power supply, e.g., a rechargeable battery, and it can include one or more transformers to achieve a power level suitable for operation of the computing device 1410 and/or one of the computing device(s) 1470, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 1418) to connect operationally to the conventional power grid. In another aspect, the power supply can include an energy conversion component, such as a solar panel, to provide additional or alternative power resources or autonomy for the computing device 1410 and/or one of the computing device(s) 1470.

The computing device 1410 can operate in a networked environment by utilizing connections to one or more remote computing devices 1470. As an illustration, a remote computing device can be a personal computer, a portable computer, a server, a router, a network computer, a peer device or other common network node, and so on. As described herein, connections (physical and/or logical) between the computing device 1410 and a computing device of the one or more remote computing devices 1470 can be made via one or more traffic and signaling pipes 1460, which can comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

According to example embodiments of the disclosure, there may be a method for mapping magnetic field. The method may include accessing, via a magnetic sensor associated with an electronic device, information associated with a magnetic field vector at a predetermined location. The method may include accessing, via an inertial sensor associated with the electronic device, information associated with an acceleration vector of the electronic device at the predetermined location. The method may include determining a first component of the magnetic field vector based at least on the acceleration vector. The method may include determining a second component of the magnetic field vector based at least on the acceleration vector, the second component is substantially orthogonal to the first component. The method may include updating a magnetic map at the predetermined location based at least on the parallel component and the orthogonal component, the magnetic map representing a footprint of the magnetic field within a spatial region. The method may include wherein determining at least one of the first component of the magnetic field vector or the second component of the magnetic field vector comprises determining a pitch of the electronic device based at least on the acceleration vector, and determining a roll of the electronic device based at least on the acceleration vector. The method may include wherein determining at least one of the first component of the magnetic field vector or the second component of the magnetic field vector further comprises projecting the magnetic field vector onto at least one plane in an earth coordinate system. The magnetic sensor may be oriented in a first direction, and may further include determining a second magnetic field vector at substantially the predetermined location via the magnetic sensor oriented in a second direction different from the first direction. The method may further include determining a second acceleration vector of the electronic device at substantially the predetermined location via the inertial sensor associated with the electronic device, wherein the electronic device is oriented in the second direction. The method may further include determining a first component of the second magnetic field vector based at least on the second acceleration vector, and determining a second component of the second magnetic field vector based at least on the second acceleration vector, the second component of the second magnetic field vector is substantially orthogonal to the first component of the second magnetic field vector. The method may include determining at least one of the first component of the second magnetic field vector or the second component of the second magnetic field vector comprises determining a second pitch of the electronic device based at least on the second acceleration vector, and determining a second roll of the electronic device based at least on the second acceleration vector. The method may include determining at least one of the first component of the second magnetic field vector or the second component of the second magnetic field vector further comprises projecting the magnetic field vector onto at least one second plane in the earth coordinate system. The method may include updating the magnetic map at the predetermined location based at least on the first component of the magnetic field vector and the second component of the magnetic field vector comprises updating the magnetic map at the predetermined location based at least on the first component of the second magnetic field vector and the second component of the second magnetic field vector. The method may further include determining an average of the first component of the first magnetic field vector and the first component of the second magnetic field vector, and determining a second average of the second component of the first magnetic field vector and the second component of the second magnetic field vector. The method may further include determining a weighted magnitude of a difference between the first component of the first magnetic field vector and the first component of the second magnetic field vector, and determining a second weighted magnitude of a difference between the second component of the first magnetic field vector and the second component of the second magnetic field vector. The method may further include updating the magnetic map at the predetermined location based at least on the average, the second average, the weighted difference, and the second weighted difference.

According to example embodiments of the disclosure, there may be a method for location sensing. The method may include accessing, via a magnetic sensor associated with an electronic device, information associated with a magnetic field vector at a predetermined location. The method may include accessing, via an inertial sensor associated with the electronic device, information associated with an acceleration vector of the electronic device at the predetermined location. The method may include determining if an accuracy of a current estimate of the location of the electronic device is within a tolerance. The method may further include, in response to positively determining that the accuracy of the current estimate of the location of the electronic device is outside the tolerance, determining a first and a second vector metric associated with the magnetic field vector based at least on the acceleration vector, normalizing the first and the second vector metric and a group of historical vector metrics representative of historical magnetic field vectors, and determining a current position estimate of the electronic device based at least on the normalized metrics. The method may further include, in response to positively determining that the accuracy of the current estimate of the location of the electronic device is within the tolerance, determining a scalar metric associated with the magnetic field vector based at least on the acceleration vector, normalizing the scalar metric and a group of historical scalar metrics associated with historical magnetic field vectors, and determining a current position estimate of the electronic device based at least on the normalized metrics. The method may further include, in response to positively determining that accuracy of the current estimate of the location of the electronic device is outside the tolerance, determining a tilt angle of the electronic device based at least on the acceleration vector, and determining if the rate of variation of the tilt angle is above a threshold. The method may further include, in response to positively determining that the rate of variation of the tilt angle is above the threshold, determining a scalar metric associated with the magnetic field vector based at least on the acceleration vector, normalizing the scalar metric and a group of historical scalar metrics associated with historical magnetic field vectors, and determining a current position estimate of the electronic device based at least on the normalized metrics. The method may further include, in response to positively determining that the rate of variation of the tilt angle is not above the threshold, determining a second vector metric associated with the magnetic field vector based at least on the acceleration vector, normalizing the second vector metric and a group of historical second vector metrics associated with historical magnetic field vectors, and determining a current position estimate of the electronic device based at least on the normalized metrics. Normalizing the vector metric and a group of historical vector metrics representative of historical magnetic field vectors may include determining a respective adjustment of a component of the vector metric and a component of each of the group of historical vector metrics, and the respective adjustment may be linear on the component of the vector metric and the component of each of the group of historical vector metrics, and may include coefficients based at least on the component of vector metric, a component of one metric of the group of historical vector metrics, a component of a reference vector metric associated with the vector metric, and a component of a second reference vector metric associated with the one metric of the group of historical vector metrics. Normalizing the scalar metric and a group of historical scalar metrics representative of historical magnetic field vectors may include determining a respective adjustment of the scalar metric and each of the group of historical scalar metrics, and the respective adjustment may be linear on the respective scalar metric and the group of scalar metrics, and may include coefficients based at least on the scalar metric, one metric of the group of historical scalar metrics, a reference scalar metric associated with the scalar metric, and the one metric of the group of historical scalar metrics.

In example embodiments of the disclosure, there may be a computing device for mapping magnetic field. The computing device may include at least one memory device having instructions encoded thereon, and at least one processor functionally coupled to the at least one memory device and configured, in response to execution of the instructions. The at least one processor may be configured, in response to execution of the instructions, to access, via a magnetic sensor associated with an electronic device, information associated with a magnetic field vector at a predetermined location. The at least one processor may be configured, in response to execution of the instructions, to access, via an inertial sensor associated with the electronic device, information associated with an acceleration vector of the electronic device at the predetermined location. The at least one processor may be configured, in response to execution of the instructions, to determine a first component of the magnetic field vector based at least on the acceleration vector. The at least one processor may be configured, in response to execution of the instructions, to determine a second component of the magnetic field vector based at least on the acceleration vector, the second component is substantially orthogonal to the first component. The at least one processor may be configured, in response to execution of the instructions, to update a magnetic map at the predetermined location based at least on the parallel component and the orthogonal component, the magnetic map representing a footprint of the magnetic field within a spatial region. The at least one processor may be further configured, in response to execution of the instructions, to determine a pitch of the electronic device based at least on the acceleration vector, and determining a roll of the electronic device based at least on the acceleration vector. The at least one processor may be further configured, in response to execution of the instructions, to project the magnetic field vector onto at least one plane in an earth coordinate system. The magnetic sensor may be oriented in a first direction, and the at least processor may be further configured, in response to execution of the instructions, to determine a second magnetic field vector at substantially the predetermined location via the magnetic sensor oriented in a second direction different from the first direction. The at least one processor may be further configured, in response to execution of the instructions, to determine a second acceleration vector of the electronic device at substantially the predetermined location via the inertial sensor associated with the electronic device, wherein the electronic device is oriented in the second direction. The at least one processor may be further configured, in response to execution of the instructions, to determine a first component of the second magnetic field vector based at least on the second acceleration vector, and determine a second component of the second magnetic field vector based at least on the second acceleration vector, the second component of the second magnetic field vector is substantially orthogonal to the first component of the second magnetic field vector. The at least one processor may be further configured, in response to execution of the instructions, to determine a second pitch of the electronic device based at least on the second acceleration vector, and to determine a second roll of the electronic device based at least on the second acceleration vector. The at least one processor may be further configured, in response to execution of the instructions, to project the magnetic field vector onto at least one second plane in the earth coordinate system. The at least one processor may be further configured, in response to execution of the instructions, to update the magnetic map at the predetermined location based at least on the first component of the second magnetic field vector and the second component of the second magnetic field vector. The at least one processor may be further configured, in response to execution of the instructions, to determine an average of the first component of the first magnetic field vector and the first component of the second magnetic field vector, and to determine a second average of the second component of the first magnetic field vector and the second component of the second magnetic field vector. The at least one processor may be further configured, in response to execution of the instructions, to determine a weighted magnitude of a difference between the first component of the first magnetic field vector and the first component of the second magnetic field vector, and determine a second weighted magnitude of a difference between the second component of the first magnetic field vector and the second component of the second magnetic field vector. The at least one processor may be further configured, in response to execution of the instructions, to update the magnetic map at the predetermined location based at least on the average, the second average, the weighted difference, and the second weighted difference.

In example embodiments of the disclosure, there may be a system for mapping magnetic field. The system may include at least one memory having instructions encoded thereon, and at least one processor functionally coupled to the at least one memory and configured, in response to execution of the instructions. The at least one processor may be configured to execute the computer-executable instructions to access, via a magnetic sensor associated with an electronic device, information associated with a magnetic field vector at a predetermined location. The at least one processor may be configured, in response to execution of the instructions, to access, via an inertial sensor associated with the electronic device, information associated with an acceleration vector of the electronic device at the predetermined location. The at least one processor may be configured, in response to execution of the instructions, to determine a first component of the magnetic field vector based at least on the acceleration vector. The at least one processor may be configured, in response to execution of the instructions, to determine a second component of the magnetic field vector based at least on the acceleration vector, the second component is substantially orthogonal to the first component. The at least one processor may be further configured, in response to execution of the instructions, to update a magnetic map at the predetermined location based at least on the parallel component and the orthogonal component, the magnetic map representing a footprint of the magnetic field within a spatial region. The at least one processor may be further configured, in response to execution of the instructions, to determine a pitch of the electronic device based at least on the acceleration vector, and to determine a roll of the electronic device based at least on the acceleration vector. The at least one processor may be further configured, in response to execution of the instructions, to project the magnetic field vector onto at least one plane in an earth coordinate system. The magnetic sensor may be oriented in a first direction, and the at least one processor may be further configured, in response to execution of the instructions, to determine a second magnetic field vector at substantially the predetermined location via the magnetic sensor oriented in a second direction different from the first direction. The at least one processor may be further configured, in response to execution of the instructions, to determine a second acceleration vector of the electronic device at substantially the predetermined location via the inertial sensor associated with the electronic device, wherein the electronic device is oriented in the second direction. the at least one processor may be further configured, in response to execution of the instructions, to determine a first component of the second magnetic field vector based at least on the second acceleration vector, and to determine a second component of the second magnetic field vector based at least on the second acceleration vector, the second component of the second magnetic field vector is substantially orthogonal to the first component of the second magnetic field vector. The at least one processor may be further configured, in response to execution of the instructions, to determine a second pitch of the electronic device based at least on the second acceleration vector, and to determine a second roll of the electronic device based at least on the second acceleration vector. The at least one processor may be further configured, in response to execution of the instructions, to project the magnetic field vector onto at least one second plane in the earth coordinate system. The at least one processor may be further configured, in response to execution of the instructions, to update the magnetic map at the predetermined location based at least on the first component of the second magnetic field vector and the second component of the second magnetic field vector. The at least one processor may be further configured, in response to execution of the instructions, to determine an average of the first component of the first magnetic field vector and the first component of the second magnetic field vector, and to determine a second average of the second component of the first magnetic field vector and the second component of the second magnetic field vector. The at least one processor may be further configured, in response to execution of the instructions, to determine a weighted magnitude of a difference between the first component of the first magnetic field vector and the first component of the second magnetic field vector, and to determine a second weighted magnitude of a difference between the second component of the first magnetic field vector and the second component of the second magnetic field vector. The at least one processor may be further configured, in response to execution of the instructions, to update the magnetic map at the predetermined location based at least on the average, the second average, the weighted difference, and the second weighted difference.

In another example embodiment, there is disclosed at least one computer-readable non-transitory storage medium encoded with computer-accessible instructions. The at least one computer-readable non-transitory storage medium may store instructions that, in response to execution, cause at least one processor to perform mapping magnetic field operations. The mapping magnetic field operations may include accessing, via a magnetic sensor associated with an electronic device, information associated with a magnetic field vector at a predetermined location. The mapping magnetic field operations may further include accessing, via an inertial sensor associated with the electronic device, information associated with an acceleration vector of the electronic device at the predetermined location. The mapping magnetic field operations may further include determining a first component of the magnetic field vector based at least on the acceleration vector. The mapping magnetic field operations may further include determining a second component of the magnetic field vector based at least on the acceleration vector, the second component is substantially orthogonal to the first component. The mapping magnetic field operations may further include updating a magnetic map at the predetermined location based at least on the parallel component and the orthogonal component, the magnetic map representing a footprint of the magnetic field within a spatial region. Determining at least one of the first component of the magnetic field vector or the second component of the magnetic field vector may include determining a pitch of the electronic device based at least on the acceleration vector, and determining a roll of the electronic device based at least on the acceleration vector. Determining at least one of the first component of the magnetic field vector or the second component of the magnetic field vector may include projecting the magnetic field vector onto at least one plane in an earth coordinate system. The magnetic sensor may be oriented in a first direction, and may include determining a second magnetic field vector at substantially the predetermined location via the magnetic sensor oriented in a second direction different from the first direction. The mapping magnetic field operations may include determining a second acceleration vector of the electronic device at substantially the predetermined location via the inertial sensor associated with the electronic device, wherein the electronic device is oriented in the second direction. The mapping magnetic field operations may further include determining a first component of the second magnetic field vector based at least on the second acceleration vector, and determining a second component of the second magnetic field vector based at least on the second acceleration vector, the second component of the second magnetic field vector is substantially orthogonal to the first component of the second magnetic field vector. Determining at least one of the first component of the second magnetic field vector or the second component of the second magnetic field vector may include determining a second pitch of the electronic device based at least on the second acceleration vector, and determining a second roll of the electronic device based at least on the second acceleration vector. Determining at least one of the first component of the second magnetic field vector or the second component of the second magnetic field vector may include projecting the magnetic field vector onto at least one second plane in the earth coordinate system. Updating the magnetic map at the predetermined location based at least on the first component of the magnetic field vector and the second component of the magnetic field vector may include updating the magnetic map at the predetermined location based at least on the first component of the second magnetic field vector and the second component of the second magnetic field vector. The mapping magnetic field operations may further include determining an average of the first component of the first magnetic field vector and the first component of the second magnetic field vector, and determining a second average of the second component of the first magnetic field vector and the second component of the second magnetic field vector. The mapping magnetic field operations may further include determining a weighted magnitude of a difference between the first component of the first magnetic field vector and the first component of the second magnetic field vector, and determining a second weighted magnitude of a difference between the second component of the first magnetic field vector and the second component of the second magnetic field vector. The mapping magnetic field operations may further include updating the magnetic map at the predetermined location based at least on the average, the second average, the weighted difference, and the second weighted difference.

In example embodiments of the disclosure, there may be an apparatus for mapping magnetic field. The apparatus for mapping magnetic field may include means for accessing, via a magnetic sensor associated with an electronic device, information associated with a magnetic field vector at a predetermined location. The apparatus for mapping magnetic field may include means for accessing, via an inertial sensor associated with the electronic device, information associated with an acceleration vector of the electronic device at the predetermined location. The apparatus for mapping magnetic field may include means for determining a first component of the magnetic field vector based at least on the acceleration vector. The apparatus for mapping magnetic field may include means for determining a second component of the magnetic field vector based at least on the acceleration vector, the second component is substantially orthogonal to the first component. The apparatus for mapping magnetic field may include means for updating a magnetic map at the predetermined location based at least on the parallel component and the orthogonal component, the magnetic map representing a footprint of the magnetic field within a spatial region. The means for determining at least one of the first component of the magnetic field vector or the second component of the magnetic field vector may include means for determining a pitch of the electronic device based at least on the acceleration vector, and determining a roll of the electronic device based at least on the acceleration vector. The means for determining at least one of the first component of the magnetic field vector or the second component of the magnetic field vector may include projecting the magnetic field vector onto at least one plane in an earth coordinate system. The magnetic sensor may be oriented in a first direction, and may further include means for determining a second magnetic field vector at substantially the predetermined location via the magnetic sensor oriented in a second direction different from the first direction. The apparatus for mapping magnetic field may include means for determining a second acceleration vector of the electronic device at substantially the predetermined location via the inertial sensor associated with the electronic device, wherein the electronic device is oriented in the second direction. The apparatus for mapping magnetic field may include means for determining a first component of the second magnetic field vector based at least on the second acceleration vector, and means for determining a second component of the second magnetic field vector based at least on the second acceleration vector, the second component of the second magnetic field vector may be substantially orthogonal to the first component of the second magnetic field vector. The means for determining at least one of the first component of the second magnetic field vector or the second component of the second magnetic field vector may include means for determining a second pitch of the electronic device based at least on the second acceleration vector, and means for determining a second roll of the electronic device based at least on the second acceleration vector. The means for determining at least one of the first component of the second magnetic field vector or the second component of the second magnetic field vector further may include a means for projecting the magnetic field vector onto at least one second plane in the earth coordinate system. The means for updating the magnetic map at the predetermined location based at least on the first component of the magnetic field vector and the second component of the magnetic field vector may include means for updating the magnetic map at the predetermined location based at least on the first component of the second magnetic field vector and the second component of the second magnetic field vector. The apparatus for mapping magnetic field may include means for determining an average of the first component of the first magnetic field vector and the first component of the second magnetic field vector, and means for determining a second average of the second component of the first magnetic field vector and the second component of the second magnetic field vector. The apparatus for mapping magnetic field may include means for determining a weighted magnitude of a difference between the first component of the first magnetic field vector and the first component of the second magnetic field vector, and means for determining a second weighted magnitude of a difference between the second component of the first magnetic field vector and the second component of the second magnetic field vector. The apparatus for mapping magnetic field may include means for updating the magnetic map at the predetermined location based at least on the average, the second average, the weighted difference, and the second weighted difference.

In example embodiments of the disclosure, there may be a computing device for location sensing. The computing device for location sensing may include at least one memory device having instructions encoded thereon, and at least one processor functionally coupled to the at least one memory device and configured, in response to execution of the instructions. The at least one processor may be configured, in response to execution of the instructions, to access information associated with a magnetic field vector at a predetermined location. The at least one processor may be configured, in response to execution of the instructions, to access information associated with an acceleration vector of the electronic device at the predetermined location. The at least one processor may be configured, in response to execution of the instructions, to determine if an accuracy of a current estimate of the location of the electronic device is within a tolerance. The at least one processor may be configured, in response to execution of the instructions, in response to a positive determination that the accuracy of the current estimate of the location of the electronic device is outside the tolerance, to determine a first and a second vector metric associated with the magnetic field vector based at least on the acceleration vector, to normalize the first and the second vector metric and a group of historical vector metrics representative of historical magnetic field vectors, and to determine a current position estimate of the electronic device based at least on the normalized metrics. The at least one processor may be configured, in response to execution of the instructions, in response to the positive determination that the accuracy of the current estimate of the location of the electronic device is within the tolerance, to determine a scalar metric associated with the magnetic field vector based at least on the acceleration vector, to normalize the scalar metric and a group of historical scalar metrics associated with historical magnetic field vectors, and to determine a current position estimate of the electronic device based at least on the normalized metrics. The at least one processor may be configured, in response to execution of the instructions, in response to the positive determination that accuracy of the current estimate of the location of the electronic device is outside the tolerance, to determine a tilt angle of the electronic device based at least on the acceleration vector, and to determine if the rate of variation of the tilt angle is above a threshold. The at least one processor may be configured, in response to execution of the instructions, in response to the positive determination that the rate of variation of the tilt angle is above the threshold, to determine a scalar metric associated with the magnetic field vector based at least on the acceleration vector, normalize the scalar metric and a group of historical scalar metrics associated with historical magnetic field vectors, and to determine a current position estimate of the electronic device based at least on the normalized metrics. The at least one processor may be configured, in response to execution of the instructions, in response to the positive determination that the rate of variation of the tilt angle is not above the threshold, to determine a second vector metric associated with the magnetic field vector based at least on the acceleration vector, to normalize the second vector metric and a group of historical second vector metrics associated with historical magnetic field vectors, and to determine a current position estimate of the electronic device based at least on the normalized metrics. The at least one processor may be further configured, in response to execution of the instructions, to determine a respective adjustment of a component of the vector metric and a component of each of the group of historical vector metrics, and wherein the respective adjustment may be linear on the component of the vector metric and the component of each of the group of historical vector metrics, and may include coefficients based at least on the component of vector metric, a component of one metric of the group of historical vector metrics, a component of a reference vector metric associated with the vector metric, and a component of a second reference vector metric associated with the one metric of the group of historical vector metrics. The at least one processor may be further configured, in response to execution of the instructions, to determine a respective adjustment of the scalar metric and each of the group of historical scalar metrics, and wherein the respective adjustment may be linear on the respective scalar metric and the group of scalar metrics, and may include coefficients based at least on the scalar metric, one metric of the group of historical scalar metrics, a reference scalar metric associated with the scalar metric, and the one metric of the group of historical scalar metrics.

In example embodiments of the disclosure, there may be a system for location sensing. The system may include at least one memory having instructions encoded thereon, and at least one processor functionally coupled to the at least one memory and configured, in response to execution of the instructions. The at least one processor may be further configured, in response to execution of the instructions, to execute the computer-executable instructions to access information associated with a magnetic field vector at a predetermined location. The at least one processor may be further configured, in response to execution of the instructions, to execute the computer-executable instructions to access information associated with an acceleration vector of the electronic device at the predetermined location. The at least one processor may be further configured, in response to execution of the instructions, to determine if an accuracy of a current estimate of the location of the electronic device is within a tolerance. In response to the positive determination that the accuracy of the current estimate of the location of the electronic device is outside the tolerance, the at least one processor may be further configured, in response to execution of the instructions, to determine a first and a second vector metric associated with the magnetic field vector based at least on the acceleration vector, to normalize the first and the second vector metric and a group of historical vector metrics representative of historical magnetic field vectors, and to determine a current position estimate of the electronic device based at least on the normalized metrics. The at least one processor may be further configured, in response to execution of the instructions, in response to the positive determination that the accuracy of the current estimate of the location of the electronic device is within the tolerance, to determine a scalar metric associated with the magnetic field vector based at least on the acceleration vector, to normalize the scalar metric and a group of historical scalar metrics associated with historical magnetic field vectors, and to determine a current position estimate of the electronic device based at least on the normalized metrics. The at least one processor may be further configured, in response to execution of the instructions, in response to the positive determination that accuracy of the current estimate of the location of the electronic device is outside the tolerance, to determine a tilt angle of the electronic device based at least on the acceleration vector, and to determine if the rate of variation of the tilt angle is above a threshold. The at least one processor may be further configured, in response to execution of the instructions, in response to the positive determination that the rate of variation of the tilt angle is above the threshold, to determine a scalar metric associated with the magnetic field vector based at least on the acceleration vector, to normalize the scalar metric and a group of historical scalar metrics associated with historical magnetic field vectors, and to determine a current position estimate of the electronic device based at least on the normalized metrics. The at least one processor may be further configured, in response to execution of the instructions, in response to the positive determination that the rate of variation of the tilt angle is not above the threshold, to determine a second vector metric associated with the magnetic field vector based at least on the acceleration vector, normalize the second vector metric and a group of historical second vector metrics associated with historical magnetic field vectors, and to determine a current position estimate of the electronic device based at least on the normalized metrics. The at least one processor may be further configured, in response to execution of the instructions, to determine a respective adjustment of a component of the vector metric and a component of each of the group of historical vector metrics, and wherein the respective adjustment may be linear on the component of the vector metric and the component of each of the group of historical vector metrics, and may include coefficients based at least on the component of vector metric, a component of one metric of the group of historical vector metrics, a component of a reference vector metric associated with the vector metric, and a component of a second reference vector metric associated with the one metric of the group of historical vector metrics. The at least one processor may be further configured, in response to execution of the instructions, to determine a respective adjustment of the scalar metric and each of the group of historical scalar metrics, and wherein the respective adjustment may be linear on the respective scalar metric and the group of scalar metrics, and may include coefficients based at least on the scalar metric, one metric of the group of historical scalar metrics, a reference scalar metric associated with the scalar metric, and the one metric of the group of historical scalar metrics.

In another example embodiment, there is disclosed at least one computer-readable non-transitory storage medium encoded with computer-accessible instructions. The at least one computer-readable non-transitory storage medium may store instructions that, in response to execution, cause at least one processor to perform location sensing operations. The location sensing operations may include accessing, via a magnetic sensor associated with an electronic device, information associated with a magnetic field vector at a predetermined location. The location sensing operations may include accessing, via an inertial sensor associated with the electronic device, information associated with an acceleration vector of the electronic device at the predetermined location. The location sensing operations may include determining if an accuracy of a current estimate of the location of the electronic device is within a tolerance. In response to positively determining that the accuracy of the current estimate of the location of the electronic device is outside the tolerance, the location sensing operations may include determining a first and a second vector metric associated with the magnetic field vector based at least on the acceleration vector, normalizing the first and the second vector metric and a group of historical vector metrics representative of historical magnetic field vectors, and determining a current position estimate of the electronic device based at least on the normalized metrics. In response to positively determining that the accuracy of the current estimate of the location of the electronic device is within the tolerance, the location sensing operations may further include determining a scalar metric associated with the magnetic field vector based at least on the acceleration vector, normalizing the scalar metric and a group of historical scalar metrics associated with historical magnetic field vectors, and determining a current position estimate of the electronic device based at least on the normalized metrics. In response to positively determining that accuracy of the current estimate of the location of the electronic device is outside the tolerance, the location sensing operations may further include determining a tilt angle of the electronic device based at least on the acceleration vector, and determining if the rate of variation of the tilt angle is above a threshold. In response to positively determining that the rate of variation of the tilt angle is above the threshold, the location sensing operations may further include determining a scalar metric associated with the magnetic field vector based at least on the acceleration vector, normalizing the scalar metric and a group of historical scalar metrics associated with historical magnetic field vectors, and determining a current position estimate of the electronic device based at least on the normalized metrics. In response to positively determining that the rate of variation of the tilt angle is not above the threshold, the location sensing operations may further include determining a second vector metric associated with the magnetic field vector based at least on the acceleration vector, normalizing the second vector metric and a group of historical second vector metrics associated with historical magnetic field vectors, and determining a current position estimate of the electronic device based at least on the normalized metrics. The location sensing operations may further include determining a respective adjustment of a component of the vector metric and a component of each of the group of historical vector metrics, and wherein the respective adjustment may be linear on the component of the vector metric and the component of each of the group of historical vector metrics, and may include coefficients based at least on the component of vector metric, a component of one metric of the group of historical vector metrics, a component of a reference vector metric associated with the vector metric, and a component of a second reference vector metric associated with the one metric of the group of historical vector metrics. The location sensing operations may further include determining a respective adjustment of the scalar metric and each of the group of historical scalar metrics, and wherein the respective adjustment may be linear on the respective scalar metric and the group of scalar metrics, and may include coefficients based at least on the scalar metric, one metric of the group of historical scalar metrics, a reference scalar metric associated with the scalar metric, and the one metric of the group of historical scalar metrics.

In another example embodiment, there is disclosed an apparatus for location sensing. The apparatus for location sensing may include the means for accessing, via a magnetic sensor associated with an electronic device, information associated with a magnetic field vector at a predetermined location. The apparatus for location sensing may include the means for accessing, via an inertial sensor associated with the electronic device, information associated with an acceleration vector of the electronic device at the predetermined location. The apparatus for location sensing may include the means for determining if an accuracy of a current estimate of the location of the electronic device is within a tolerance. The apparatus for location sensing may include in response to positively determining that the accuracy of the current estimate of the location of the electronic device is outside the tolerance, means for determining a first and a second vector metric associated with the magnetic field vector based at least on the acceleration vector. The apparatus for location sensing may include means for normalizing the first and the second vector metric and a group of historical vector metrics representative of historical magnetic field vectors. The apparatus for location sensing may include means for determining a current position estimate of the electronic device based at least on the normalized metrics. In response to positively determining that the accuracy of the current estimate of the location of the electronic device is within the tolerance, the apparatus for location sensing may further include means for determining a scalar metric associated with the magnetic field vector based at least on the acceleration vector, a means for normalizing the scalar metric and a group of historical scalar metrics associated with historical magnetic field vectors, and means for determining a current position estimate of the electronic device based at least on the normalized metrics. In response to positively determining that accuracy of the current estimate of the location of the electronic device is outside the tolerance, the apparatus for location sensing may further include means for determining a tilt angle of the electronic device based at least on the acceleration vector, and means for determining if the rate of variation of the tilt angle is above a threshold. In response to positively determining that the rate of variation of the tilt angle is above the threshold, the apparatus for location sensing may further include means for determining a scalar metric associated with the magnetic field vector based at least on the acceleration vector, means for normalizing the scalar metric and a group of historical scalar metrics associated with historical magnetic field vectors, and means for determining a current position estimate of the electronic device based at least on the normalized metrics. In response to positively determining that the rate of variation of the tilt angle is not above the threshold, the apparatus for location sensing may further include means for determining a second vector metric associated with the magnetic field vector based at least on the acceleration vector, means for normalizing the second vector metric and a group of historical second vector metrics associated with historical magnetic field vectors, and means for determining a current position estimate of the electronic device based at least on the normalized metrics. The means for normalizing the vector metric and a group of historical vector metrics representative of historical magnetic field vectors may include means for determining a respective adjustment of a component of the vector metric and a component of each of the group of historical vector metrics, and wherein the respective adjustment may be linear on the component of the vector metric and the component of each of the group of historical vector metrics, and may include coefficients based at least on the component of vector metric, a component of one metric of the group of historical vector metrics, a component of a reference vector metric associated with the vector metric, and a component of a second reference vector metric associated with the one metric of the group of historical vector metrics. The means for normalizing the scalar metric and a group of historical scalar metrics representative of historical magnetic field vectors may include means for determining a respective adjustment of the scalar metric and each of the group of historical scalar metrics, and wherein the respective adjustment may be linear on the respective scalar metric and the group of scalar metrics, and may include coefficients based at least on the scalar metric, one metric of the group of historical scalar metrics, a reference scalar metric associated with the scalar metric, and the one metric of the group of historical scalar metrics.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “platform,” “system,” “architecture,” “interface,” “unit,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that provides, at least in part, the functionality of the electronic components. An interface can include input/output (I/O) components as well as associated processor, application, and/or other programming components. The terms “component,” “environment,” “platform,” “system,” “architecture,” “interface,” “unit,” “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In certain embodiments, processors can utilize nanoscale architectures such as, but not limited to, molecular and quantum-dot based transistors, switches and gates, in order to optimize space usage or enhance performance of user equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components;” functional entities embodied in or comprising a memory device or storage device; or components forming the memory device or storage device. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, and techniques that can provide that can permit magnetic mapping and location sensing in accordance with this disclosure. It is, of course, not possible to describe every conceivable combination of elements and/or methods for purposes of describing the various features of the disclosure, but it can be recognized that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. A method for location sensing, comprising:
accessing, via a magnetic sensor associated with an electronic device, information associated with a magnetic field vector at a predetermined location;
accessing, via an inertial sensor associated with the electronic device, information associated with an acceleration vector of the electronic device at the predetermined location;
determining if an accuracy of a current estimate of the location of the electronic device is within a tolerance; and
in response to positively determining that the accuracy of the current estimate of the location of the electronic device is outside the tolerance, determining a first and a second vector metric associated with the magnetic field vector based at least on the acceleration vector,
normalizing the first and the second vector metric and a group of historical vector metrics representative of historical magnetic field vectors, and
determining a current position estimate of the electronic device based at least on the normalized metrics.

2. The method of claim 1, in response to positively determining that the accuracy of the current estimate of the location of the electronic device is within the tolerance, further comprising determining a scalar metric associated with the magnetic field vector based at least on the acceleration vector,
normalizing the scalar metric and a group of historical scalar metrics associated with historical magnetic field vectors, and
determining a current position estimate of the electronic device based at least on the normalized metrics.

3. The method of claim 1, in response to positively determining that accuracy of the current estimate of the location of the electronic device is outside the tolerance, further comprising determining a tilt angle of the electronic device based at least on the acceleration vector, and
determining if the rate of variation of the tilt angle is above a threshold.

4. The method of claim 3, in response to positively determining that the rate of variation of the tilt angle is above the threshold, further comprising determining a scalar metric associated with the magnetic field vector based at least on the acceleration vector,
normalizing the scalar metric and a group of historical scalar metrics associated with historical magnetic field vectors, and
determining a current position estimate of the electronic device based at least on the normalized metrics.

5. The method of claim 3, in response to positively determining that the rate of variation of the tilt angle is not above the threshold, further comprising determining a second vector metric associated with the magnetic field vector based at least on the acceleration vector,
normalizing the second vector metric and a group of historical second vector metrics associated with historical magnetic field vectors, and
determining a current position estimate of the electronic device based at least on the normalized metrics.

6. The method of claim 1, wherein normalizing the vector metric and a group of historical vector metrics representative of historical magnetic field vectors comprises determining a respective adjustment of a component of the vector metric and a component of each of the group of historical vector metrics, and
wherein the respective adjustment is linear on the component of the vector metric and the component of each of the group of historical vector metrics, and comprises coefficients based at least on the component of vector metric, a component of one metric of the group of historical vector metrics, a component of a reference vector metric associated with the vector metric, and a component of a second reference vector metric associated with the one metric of the group of historical vector metrics.

7. The method of claim 4, wherein normalizing the scalar metric and a group of historical scalar metrics representative of historical magnetic field vectors comprises determining a respective adjustment of the scalar metric and each of the group of historical scalar metrics, and
wherein the respective adjustment is linear on the respective scalar metric and the group of scalar metrics, and comprises coefficients based at least on the scalar metric, one metric of the group of historical scalar metrics, a reference scalar metric associated with the scalar metric, and the one metric of the group of historical scalar metrics.

8. A computing device for location sensing, comprising:
at least one memory device having instructions encoded thereon; and
at least one processor functionally coupled to the at least one memory device and configured, in response to execution of the instructions,
to access information associated with a magnetic field vector at a predetermined location;
to access information associated with an acceleration vector of the electronic device at the predetermined location;
to determine if an accuracy of a current estimate of the location of the electronic device is within a tolerance; and
in response to a positive determination that the accuracy of the current estimate of the location of the electronic device is outside the tolerance, to determine a first and a second vector metric associated with the magnetic field vector based at least on the acceleration vector,
to normalize the first and the second vector metric and a group of historical vector metrics representative of historical magnetic field vectors, and
to determine a current position estimate of the electronic device based at least on the normalized metrics.

9. The computing device of claim 8, in response to the positive determination that the accuracy of the current estimate of the location of the electronic device is within the tolerance, the at least one processor is further configured, in response to execution of the instructions, to determine a scalar metric associated with the magnetic field vector based at least on the acceleration vector,
to normalize the scalar metric and a group of historical scalar metrics associated with historical magnetic field vectors, and
to determine a current position estimate of the electronic device based at least on the normalized metrics.

10. The computing device of claim 8, in response to the positive determination that accuracy of the current estimate of the location of the electronic device is outside the tolerance, the at least one processor is further configured, in response to execution of the instructions, to determine a tilt angle of the electronic device based at least on the acceleration vector, and
to determine if the rate of variation of the tilt angle is above a threshold.

11. The computing device of claim 10, in response to the positive determination that the rate of variation of the tilt angle is above the threshold, the at least one processor is further configured, in response to execution of the instructions, to determine a scalar metric associated with the magnetic field vector based at least on the acceleration vector,
to normalize the scalar metric and a group of historical scalar metrics associated with historical magnetic field vectors, and
to determine a current position estimate of the electronic device based at least on the normalized metrics.

12. The computing device of claim 10, in response to the positive determination that the rate of variation of the tilt angle is not above the threshold, the at least one processor is further configured, in response to execution of the instructions, to determine a second vector metric associated with the magnetic field vector based at least on the acceleration vector,
to normalize the second vector metric and a group of historical second vector metrics associated with historical magnetic field vectors, and
to determine a current position estimate of the electronic device based at least on the normalized metrics.

13. The computing device of claim 8, wherein the at least one processor is further configured, in response to execution of the instructions, to determine a respective adjustment of a component of the vector metric and a component of each of the group of historical vector metrics, and
wherein the respective adjustment is linear on the component of the vector metric and the component of each of the group of historical vector metrics, and comprises coefficients based at least on the component of vector metric, a component of one metric of the group of historical vector metrics, a component of a reference vector metric associated with the vector metric, and a component of a second reference vector metric associated with the one metric of the group of historical vector metrics.

14. The computing device of claim 11, wherein the at least one processor is further configured, in response to execution of the instructions, to determine a respective adjustment of the scalar metric and each of the group of historical scalar metrics, and
wherein the respective adjustment is linear on the respective scalar metric and the group of scalar metrics, and comprises coefficients based at least on the scalar metric, one metric of the group of historical scalar metrics, a reference scalar metric associated with the scalar metric, and the one metric of the group of historical scalar metrics.

15. A system for location sensing, comprising:
at least one memory that stores computer-executable instructions; and
at least one processor coupled to the at least one memory and configured, in response to execution of the instructions,
to access information associated with a magnetic field vector at a predetermined location;
to access information associated with an acceleration vector of the electronic device at the predetermined location;
to determine if an accuracy of a current estimate of the location of the electronic device is within a tolerance; and
in response to a positive determination that the accuracy of the current estimate of the location of the electronic device is outside the tolerance, to determine a first and a second vector metric associated with the magnetic field vector based at least on the acceleration vector,
to normalize the first and the second vector metric and a group of historical vector metrics representative of historical magnetic field vectors, and
to determine a current position estimate of the electronic device based at least on the normalized metrics.

16. The system of claim 15, in response to the positive determination that the accuracy of the current estimate of the location of the electronic device is within the tolerance, the at least one processor is further configured, in response to execution of the instructions, to determine a scalar metric associated with the magnetic field vector based at least on the acceleration vector,
to normalize the scalar metric and a group of historical scalar metrics associated with historical magnetic field vectors, and
to determine a current position estimate of the electronic device based at least on the normalized metrics.

17. The system of claim 15, wherein the at least one processor is further configured, in response to execution of the instructions, to determine a respective adjustment of a component of the vector metric and a component of each of the group of historical vector metrics, and
wherein the respective adjustment is linear on the component of the vector metric and the component of each of the group of historical vector metrics, and comprises coefficients based at least on the component of vector metric, a component of one metric of the group of historical vector metrics, a component of a reference vector metric associated with the vector metric, and a component of a second reference vector metric associated with the one metric of the group of historical vector metrics.

18. The system of claim 17, wherein the at least one processor is further configured, in response to execution of the instructions, to determine a respective adjustment of the scalar metric and each of the group of historical scalar metrics, and
wherein the respective adjustment is linear on the respective scalar metric and the group of scalar metrics, and comprises coefficients based at least on the scalar metric, one metric of the group of historical scalar metrics, a reference scalar metric associated with the scalar metric, and the one metric of the group of historical scalar metrics.

19. At least one computer-readable non-transitory storage medium encoded with computer-accessible instructions that, in response to execution, cause at least one processor to perform location sensing operations comprising:
accessing, via a magnetic sensor associated with an electronic device, information associated with a magnetic field vector at a predetermined location;
accessing, via an inertial sensor associated with the electronic device, information associated with an acceleration vector of the electronic device at the predetermined location;
determining if an accuracy of a current estimate of the location of the electronic device is within a tolerance; and
in response to positively determining that the accuracy of the current estimate of the location of the electronic device is outside the tolerance, determining a first and a second vector metric associated with the magnetic field vector based at least on the acceleration vector,
normalizing the first and the second vector metric and a group of historical vector metrics representative of historical magnetic field vectors, and
determining a current position estimate of the electronic device based at least on the normalized metrics.

20. The at least one computer-readable non-transitory storage medium of claim 19, in response to positively determining that the accuracy of the current estimate of the location of the electronic device is within the tolerance, the location sensing operations further comprise determining a scalar metric associated with the magnetic field vector based at least on the acceleration vector,
normalizing the scalar metric and a group of historical scalar metrics associated with historical magnetic field vectors, and
determining a current position estimate of the electronic device based at least on the normalized metrics.

21. The at least one computer-readable non-transitory storage medium of claim 19, in response to positively determining that accuracy of the current estimate of the location of the electronic device is outside the tolerance, the location sensing operations further comprise determining a tilt angle of the electronic device based at least on the acceleration vector, and
determining if the rate of variation of the tilt angle is above a threshold.

22. The at least one computer-readable non-transitory storage medium of claim 21, in response to positively determining that the rate of variation of the tilt angle is above the threshold, the location sensing operations further comprise determining a scalar metric associated with the magnetic field vector based at least on the acceleration vector,
normalizing the scalar metric and a group of historical scalar metrics associated with historical magnetic field vectors, and
determining a current position estimate of the electronic device based at least on the normalized metrics.

23. The at least one computer-readable non-transitory storage medium of claim 21, in response to positively determining that the rate of variation of the tilt angle is not above the threshold, the location sensing operations further comprise determining a second vector metric associated with the magnetic field vector based at least on the acceleration vector,
normalizing the second vector metric and a group of historical second vector metrics associated with historical magnetic field vectors, and
determining a current position estimate of the electronic device based at least on the normalized metrics.

24. The at least one computer-readable non-transitory storage medium of claim 19, wherein normalizing the vector metric and a group of historical vector metrics representative of historical magnetic field vectors comprises determining a respective adjustment of a component of the vector metric and a component of each of the group of historical vector metrics, and
wherein the respective adjustment is linear on the component of the vector metric and the component of each of the group of historical vector metrics, and comprises coefficients based at least on the component of vector metric, a component of one metric of the group of historical vector metrics, a component of a reference vector metric associated with the vector metric, and a component of a second reference vector metric associated with the one metric of the group of historical vector metrics.

25. The at least one computer-readable non-transitory storage medium of claim 24, wherein normalizing the scalar metric and a group of historical scalar metrics representative of historical magnetic field vectors comprises determining a respective adjustment of the scalar metric and each of the group of historical scalar metrics, and
wherein the respective adjustment is linear on the respective scalar metric and the group of scalar metrics, and comprises coefficients based at least on the scalar metric, one metric of the group of historical scalar metrics, a reference scalar metric associated with the scalar metric, and the one metric of the group of historical scalar metrics.
